(19) United States
(12) Patent Application Publication
(10) Pub. No.: US 2018/0091949 A1
(43) Pub. Date: Mar. 29, 2018

(54) APPARATUS, SYSTEM AND METHOD OF ESTIMATING A LOCATION OF A MOBILE DEVICE

(71) Applicant: INTEL IP CORPORATION, Santa Clara, CA (US)

(72) Inventors: Itai Steiner, Tel Aviv (IL); Gaby Prechner, Rishon Lezion (IL)

(21) Appl. No.: 15/278,956

(22) Filed: Sep. 28, 2016

(51) Int. Cl. H04W 4/02; G01S 5/00; G01S 5/02

(52) U.S. Cl. CPC H04W 4/027; H04W 4/005; G01S 5/0257; G01S 5/0072

(57) ABSTRACT

Some demonstrative embodiments include apparatuses, systems and/or methods of estimating a location of a mobile station. For example, a mobile station may be configured to transmit to a wireless station a request for sensor-based position information corresponding to a change in a position of the wireless station; to process a response from the wireless station, the response comprising the sensor-based position information corresponding to the change in the position of the wireless station; and to estimate a location of the mobile station based at least on a Time of Flight (ToF) measurement between the mobile station and the wireless station, and the sensor-based position information corresponding to the change in the position of the wireless station.

### TECHNICAL FIELD

Embodiments described herein generally relate to estimating a location of a mobile device.

### BACKGROUND

Outdoor navigation is widely deployed thanks to the development of various global-navigation-satellite-systems (GNSS), e.g., Global Positioning System (GPS), GALILEO, and the like.

Recently, there has been a lot of focus on indoor navigation. This field differs from the outdoor navigation, since the indoor environment does not enable the reception of signals from GNSS satellites. As a result, a lot of effort is being directed towards solving the indoor navigation problem.

A Fine Timing Measurement (FTM) Protocol (also referred to as a “Time of Flight” (ToF) measurement), e.g., in accordance with an IEEE 802.11REVmc Specification, may include measuring a Round Trip Time (RTT) from a wireless station (STA) to a plurality of other STAs, for example, to perform trilateration and/or calculate the location of the STA.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative embodiments.

FIG. 2 is a schematic illustration of a Fine Time Measurement (FTM) procedure, in accordance with some demonstrative embodiments.

FIG. 3 is a schematic illustration of FTM measurements between a first wireless communication device and a second wireless communication device, in accordance with some demonstrative embodiments.

FIG. 4 is a schematic illustration of a location estimation of a mobile device in a deployment including a mobile responding station, in accordance with some demonstrative embodiments.

FIG. 5 is a schematic illustration of an action field of an FTM request frame, in accordance with some demonstrative embodiments.

FIG. 6 is a schematic illustration of an action field of an FTM frame, in accordance with some demonstrative embodiments.

FIG. 7 is a schematic flow-chart illustration of a method of estimating a location of a mobile device, in accordance with some demonstrative embodiments.

FIG. 8 is a schematic flow-chart illustration of a method of communicating sensor-based position information, in accordance with some demonstrative embodiments.

FIG. 9 is a schematic illustration of a product, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some embodiments may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing IEEE 802.11 standards (including IEEE 802.11-2012, IEEE Standard for Information technology—Telecommunications and information exchange between systems Local and metropolitan area networks—Specific requirements Part 11: Wireless LAN Medium Access Control (MAC) and Physical Layer (PHY) Specifications, Mar. 29, 2012; IEEE802.11ac-2013 (“IEEE P802.11ac-2013, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 4: Enhancements for Very High Throughput for Operation in Bands below 6 GHz”, December, 2013); IEEE 802.11ad (“IEEE P802.11ad-2012, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band”, 28 December, 2012); IEEE-802.11REVmc (“IEEE 802.11-REVmc™/D3.0, June 2014 draft standard for Information technology—Telecommunications and information exchange between systems Local and metropolitan area networks Specific requirements; Part 11: Wireless LAN Medium Access Control (MAC) and Physical Layer (PHY) Specification”); and/or IEEE 802.11az (IEEE 802.11az, Next Generation Positioning)) and/or future versions and/or derivatives thereof, devices and/or networks operating in accordance with existing WiFi Alliance (WFA) Specifications (including Wi-Fi Neighbor Awareness Networking (NAN) Technical Specification, Version 1.0, May 1, 2015) and/or future versions and/or derivatives thereof, devices and/or networks operating in accordance with existing WFA Peer-to-Peer (P2P) specifications (including WiFi P2P technical specification, version 1.5, Aug. 4, 2014) and/or future versions and/or derivatives thereof, devices and/or networks operating in accordance with existing Wireless-Gigabit-Alliance (WGA) specifications (including Wireless Gigabit Alliance, Inc WiGig MAC and PHY Specification Version 1.1, April 2011, Final specification) and/or future versions and/or derivatives thereof, devices and/or networks operating in accordance with existing cellular specifications and/or protocols, e.g., 3rd Generation Partnership Project (3GPP), 3GPP Long Term Evolution (LTE) and/or future versions and/or derivatives thereof, units and/or devices which are part of the above networks, and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Orthogonal Frequency-Division Multiple Access (OFDMA), Spatial Divisional Multiple Access (SDMA), FDM Time-Division Multiplexing (TDM), Time-Division Multiple Access (TDMA), Multi-User MIMO (MU-MIMO), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device.

Some demonstrative embodiments may be used in conjunction with a WLAN, e.g., a wireless fidelity (WiFi) network. Other embodiments may be used in conjunction with any other suitable wireless communication network, for example, a wireless area network, a “piconet”, a WPAN, a WVAN and the like.

Some demonstrative embodiments may be used in conjunction with a wireless communication network communicating over a frequency band of 2.4 GHz or 5 GHz. However, other embodiments may be implemented utilizing any other suitable wireless communication frequency bands, for example, a sub 1 GHz (S1G) frequency band, an Extremely High Frequency (EHF) band (the millimeter wave (mmWave) frequency band), e.g., a frequency band within the frequency band of between 20 Ghz and 300 GHZ, a WLAN frequency band, a WPAN frequency band, and the like.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and/or the like. Logic may be executed by one or more processors using memory, e.g., registers, buffers, stacks, and the like, coupled to the one or more processors, e.g., as necessary to execute the logic.

The term “antenna”, as used herein, may include any suitable configuration, structure and/or arrangement of one or more antenna elements, components, units, assemblies and/or arrays. In some embodiments, the antenna may implement transmit and receive functionalities using separate transmit and receive antenna elements. In some embodiments, the antenna may implement transmit and receive functionalities using common and/or integrated transmit/receive elements. The antenna may include, for example, a phased array antenna, a single element antenna, a set of switched beam antennas, and/or the like.

The phrase “peer to peer (PTP) communication”, as used herein, may relate to device-to-device communication over a wireless link (“peer-to-peer link”) between devices. The PTP communication may include, for example, a WiFi Direct (WFD) communication, e.g., a WFD Peer to Peer (P2P) communication, wireless communication over a direct link within a Quality of Service (QoS) basic service set (BSS), a tunneled direct-link setup (TDLS) link, a STA-to-STA communication in an independent basic service set (IBSS), or the like.

Some demonstrative embodiments are described herein with respect to WiFi communication. However, other embodiments may be implemented with respect to any other communication scheme, network, standard and/or protocol.

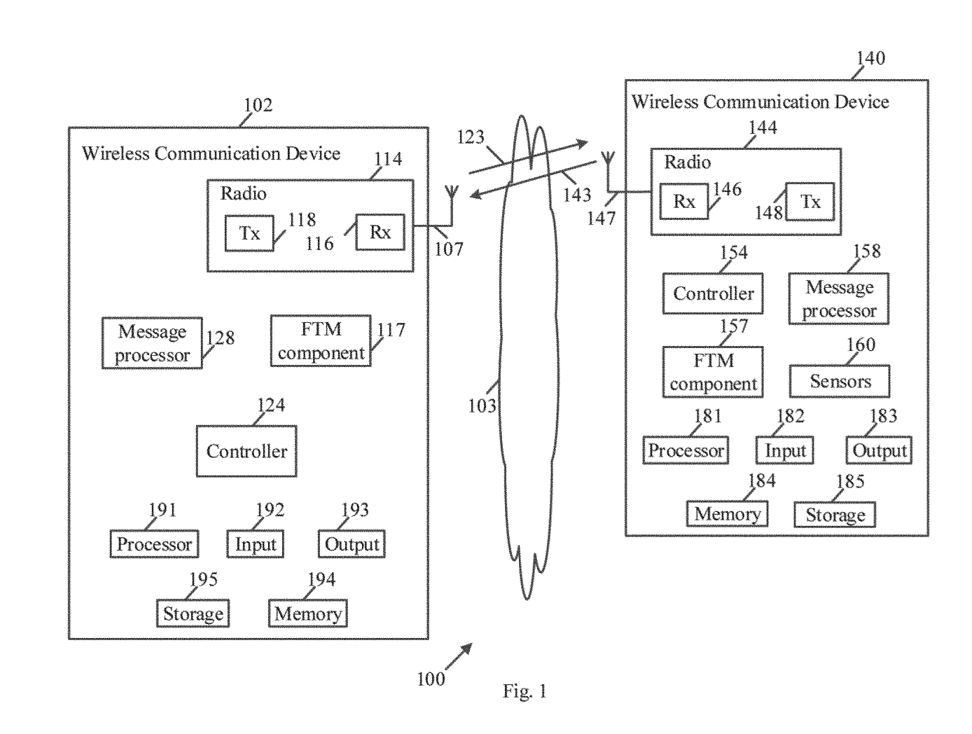

Reference is now made to FIG. 1, which schematically illustrates a system 100, in accordance with some demonstrative embodiments.

In some demonstrative embodiments, system 100 may include one or more wireless stations. For example, system 100 may include a wireless communication device 102 and/or a wireless communication device 140.

In some demonstrative embodiments, wireless communication devices 102 and/or 140 may include a mobile or a portable device.

In some demonstrative embodiments, wireless communication devices 102 and/or 140 may include, for example, a UE, an MD, a STA, an AP, a mobile computer, a laptop computer, an Ultrabook™ computer, a notebook computer, a tablet computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a video source, an audio source, a video sink, an audio sink, a stereo tuner, a broadcast radio receiver, a Personal Media Player (PMP), a digital video camera (DVC), a digital audio player, a gaming device, a data source, a data sink, a Digital Still camera (DSC), a media player, a Smartphone, a music player, or the like.

In some demonstrative embodiments, wireless communication device 102 and/or wireless communication device 140 may include, operate as, and/or perform the functionality of one or more wireless stations (STAs). For example, wireless communication device 102 may include at least one STA, and/or wireless communication device 140 may include at least one STA.

In some demonstrative embodiments, wireless communication device 102 and/or wireless communication device 140 may include, operate as, and/or perform the functionality of one or more WLAN STAs.

In some demonstrative embodiments, wireless communication device 102 and/or wireless communication device 140 may include, operate as, and/or perform the functionality of one or more Wi-Fi STAs.

In some demonstrative embodiments, wireless communication device 102 and/or wireless communication device 140 may include, operate as, and/or perform the functionality of one or more BT devices.

In some demonstrative embodiments, wireless communication device 102 and/or wireless communication device 140 may include, operate as, and/or perform the functionality of one or more Neighbor Awareness Networking (NAN) STAs.

In some demonstrative embodiments, wireless communication device 102 and/or wireless communication device 140 may include, operate as, and/or perform the functionality of, an Access Point (AP), e.g., as described below. For example, the AP may include a router, a PC, a server, a Hot-Spot and/or the like.

In some demonstrative embodiments, wireless communication device 102 and/or wireless communication device 140 may include, operate as, or perform the functionality of, a non-AP STA.

In one example, a wireless station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains a station (STA), e.g., one STA, and provides access to distribution services, via the wireless medium (WM) for associated STAs. The AP may perform any other additional or alternative functionality.

In one example, a non-access-point (non-AP) station (STA) may include a STA that is not contained within an AP. The non-AP STA may perform any other additional or alternative functionality.

In some demonstrative embodiments, wireless communication device 102 may include, for example, one or more of a processor 191, an input unit 192, an output unit 193, a memory unit 194, and/or a storage unit 195; and/or wireless communication device 140 may include, for example, one or more of a processor 181, an input unit 182, an output unit 183, a memory unit 184, and/or a storage unit 185. Wireless communication device 102 and/or wireless communication device 140 may optionally include other suitable hardware components and/or software components. In some demonstrative embodiments, some or all of the components of one or more of wireless communication device 102 and/or wireless communication device 140 may be enclosed in a common housing or packaging, and may be interconnected or operably associated using one or more wired or wireless links. In other embodiments, components of one or more of wireless communication device 102 and/or wireless communication device 140 may be distributed among multiple or separate devices.

In some demonstrative embodiments, processor 191, and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 executes instructions, for example, of an Operating System (OS) of wireless communication device 102 and/or of one or more suitable applications. Processor 181 executes instructions, for example, of an Operating System (OS) of wireless communication device 140 and/or of one or more suitable applications.

In some demonstrative embodiments, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 includes, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative embodiments, memory unit 194, memory unit 176, and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 includes, for example, a hard disk drive, a floppy disk drive, a Compact Disk (CD) drive, a CD-ROM drive, a DVD drive, or other suitable removable or non-removable storage units. Memory unit 194 and/or storage unit 195, for example, may store data processed by wireless communication device 102. Memory unit 184 and/or storage unit 185, for example, may store data processed by wireless communication device 140.

In some demonstrative embodiments, wireless communication device 102, and/or wireless communication device 140 may be capable of communicating content, data, information and/or signals via a wireless medium (WM) 103. In some demonstrative embodiments, wireless medium 103 may include, for example, a radio channel, a cellular channel, a Global Navigation Satellite System (GNSS) Channel, an RF channel, a WiFi channel, an IR channel, a Bluetooth (BT) channel, and the like.

In some demonstrative embodiments, wireless communication medium 103 may include a wireless communication channel over a 2.4 Gigahertz (GHz) frequency band, or a 5 GHz frequency band, a millimeterWave (mmWave) frequency band, e.g., a 60 GHz frequency band, a S1G band, and/or any other frequency band.

In some demonstrative embodiments, wireless communication device 102, and/or wireless communication device 140 may include one or more radios including circuitry and/or logic to perform wireless communication between wireless communication device 102, wireless communication device 140 and/or one or more other wireless communication devices. For example, wireless communication device 102 may include a radio 114, and/or wireless communication device 140 may include a radio 144.

In some demonstrative embodiments, radio 114 and/or radio 144 may include one or more wireless receivers (Rx) including circuitry and/or logic to receive wireless communication signals, RF signals, frames, blocks, transmission streams, packets, messages, data items, and/or data. For example, radio 114 may include at least one receiver 116, and/or radio 144 may include at least one receiver 146.

In some demonstrative embodiments, radios 114 and/or 144 may include one or more wireless transmitters (Tx) including circuitry and/or logic to transmit wireless communication signals, RF signals, frames, blocks, transmission streams, packets, messages, data items, and/or data. For example, radio 114 may include at least one transmitter 118, and/or radio 144 may include at least one transmitter 148.

In some demonstrative embodiments, radio 114 and/or radio 144, transmitters 118 and/or 148, and/or receivers 116 and/or 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radio 114 and/or radio 144 may include or may be implemented as part of a wireless Network Interface Card (NIC), and the like.

In some demonstrative embodiments, radios 114 and/or 144 may be configured to communicate over a 2.4 GHz band, a 5 GHz band, a S1G band, a directional band, e.g., an mmWave band, and/or any other band.

In some demonstrative embodiments, radios 114 and/or 144 may include, or may be associated with, one or more antennas 107 and/or 147, respectively.

In one example, wireless communication device 102 may include a single antenna 107. In another example, wireless communication device 102 may include two or more antennas 107.

In one example, wireless communication device 140 may include a single antenna 147. In another example, wireless communication device 140 may include two or more antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. Antennas 107 and/or 147 may include, for example, antennas suitable for directional communication, e.g., using beamforming techniques. For example, antennas 107 and/or 147 may include a phased array antenna, a multiple element antenna, a set of switched beam antennas, and/or the like. In some embodiments, antennas 107 and/or 147 may implement transmit and receive functionalities using separate transmit and receive antenna elements. In some embodiments, antennas 107 and/or 147 may implement transmit and receive functionalities using common and/or integrated transmit/receive elements.

In some demonstrative embodiments, device 102 may include a controller 124, and/or device 140 may include a controller 154. Controllers 124 and/or 154 may be configured to perform one or more communications, may generate and/or communicate one or more messages and/or transmissions, and/or may perform one or more functionalities, operations and/or procedures between devices 102, 140 and/or one or more other devices, e.g., as described below.

In some demonstrative embodiments, controllers 124 and/or 154 may include circuitry and/or logic, e.g., one or more processors including circuitry and/or logic, memory circuitry and/or logic, Media-Access Control (MAC) circuitry and/or logic, Physical Layer (PHY) circuitry and/or logic, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein.

In one example, controller 154 may include circuitry and/or logic, for example, one or more processors including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein.

In some demonstrative embodiments, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In some demonstrative embodiments, device 140 may include a message processor 158 configured to generate, process and/or access one or messages communicated by device 140.

In one example, message processor 158 may be configured to generate one or more messages to be transmitted by device 140, and/or message processor 158 may be configured to access and/or to process one or more messages received by device 140, e.g., as described below.

In some demonstrative embodiments, message processors 128 and/or 158 may include circuitry and/or logic, e.g., one or more processors including circuitry and/or logic, memory circuitry and/or logic, Media-Access Control (MAC) circuitry and/or logic, Physical Layer (PHY) circuitry and/or logic, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In some demonstrative embodiments, at least part of the functionality of message processor 128 may be implemented as part of radio 114, and/or at least part of the functionality of message processor 158 may be implemented as part of radio 144.

In some demonstrative embodiments, at least part of the functionality of message processor 128 may be implemented as part of controller 124, and/or at least part of the functionality of message processor 158 may be implemented as part of controller 154.

In other embodiments, the functionality of message processor 128 may be implemented as part of any other element of device 102, and/or the functionality of message processor 158 may be implemented as part of any other element of device 140.

In some demonstrative embodiments, at least part of the functionality of controller 124 and/or message processor 128 may be implemented by an integrated circuit, for example, a chip, e.g., a System on Chip (SoC). In one example, the chip or SoC may be configured to perform one or more functionalities of radio 114. For example, the chip or SoC may include one or more elements of controller 124, one or more elements of message processor 128, and/or one or more elements of radio 114. In one example, controller 124, message processor 128, and radio 114 may be implemented as part of the chip or SoC.

In other embodiments, controller 124, message processor 128 and/or radio 114 may be implemented by one or more additional or alternative elements of device 102.

In some demonstrative embodiments, at least part of the functionality of controller 154 and/or message processor 158 may be implemented by an integrated circuit, for example, a chip, e.g., a System on Chip (SoC). In one example, the chip or SoC may be configured to perform one or more functionalities of radio 144. For example, the chip or SoC may include one or more elements of controller 154, one or more elements of message processor 158, and/or one or more elements of radio 144. In one example, controller 154, message processor 158, and radio 144 may be implemented as part of the chip or SoC.

In other embodiments, controller 154, message processor 158 and/or radio 144 may be implemented by one or more additional or alternative elements of device 140.

In some demonstrative embodiments, wireless communication device 102 and/or wireless communication device 140 may form, or may communicate as part of, a wireless local area network (WLAN).

In some demonstrative embodiments, wireless communication device 102 and/or wireless communication device 140 may form, or may communicate as part of, a WiFi network.

In some demonstrative embodiments, wireless communication medium 103 may include a direct link, e.g., a P2P link, for example, to enable direct communication between wireless communication device 102 and wireless communication device 140.

In some demonstrative embodiments, wireless communication device 102 and/or wireless communication device 140 may perform the functionality of WFA P2P devices.

In some demonstrative embodiments, wireless communication device 102 and/or wireless communication device 140 may form, or communicate as part of, a WiFi direct services (WFDS) network.

In some demonstrative embodiments, at least one of wireless communication wireless communication device 102, and/or wireless communication device 140 may be part of a WiFi Neighbor Awareness Networking (NAN) network. For example, wireless communication device 102 may include a NAN device, which may be part of a NAN network, while wireless communication device 140 may not include a NAN device and may not be part of a NAN network.

In other embodiments, wireless communication device 102 and/or wireless communication device 140 may form, and/or communicate as part of, any other network.

In some demonstrative embodiments, wireless communication devices 102 and/or 140 may be configured to perform one or more operations and/or communications, for example, of one or more time-based range measurements, e.g., as described below.

In some demonstrative embodiments, wireless communication devices 102 and/or 140 may be configured to perform positioning measurements and/or communications, ranging measurements and/or communications, proximity measurements and/or communications, location estimation measurements and/or communications, and/or Time of Flight (ToF) (also referred to as “Fine Time Measurement (FTM)”) measurements and/or, e.g., as described below.

In some demonstrative embodiments, wireless communication devices 102 and/or 140 may be configured to perform one or more time-based range measurements.

In some demonstrative embodiments, the one or more time-based range measurements may be configured to enable a mobile device, e.g., wireless communication device 102, to estimate a location of the mobile device, for example, to provide one or more location based services to one or more applications, e.g., a social application, a navigation application, a location based advertising application, and/or the like, of the mobile device.

In one example, wireless communication device 102 may include a Smartphone and wireless communication device 140 may include a location responder, which may be located in a shop, e.g., in a shopping mall. According to this example, wireless communication device 102 may perform one or more time-based range measurements with wireless station wireless communication device 140 and/or one or more other responder stations, for example, to determine a location of wireless communication device 102, for example, to receive sale offers from the shop, e.g., when wireless communication device 102 is within the shop.

In some demonstrative embodiments, wireless communication devices 102 and/or 140 may be configured to perform one or more operations and/or communications, for example, according to a Fine Time Measurement (FTM) procedure and/or protocol, e.g., as described below.

In some demonstrative embodiments, wireless communication device 102 and/or wireless communication device 140 may be configured to perform one or more FTM measurements, ToF measurements, positioning measurements and/or communications, ranging measurements and/or communications, proximity measurements and/or communications, location estimation measurements and/or communications.

In some demonstrative embodiments, wireless communication devices 102 and/or 140 may be configured to perform any other additional or alternative positioning measurements and/or communications, ranging measurements and/or communications, proximity measurements and/or communications, location estimation measurements and/or communications, for example, and/or according to any other additional or alternative procedure and/or protocol, e.g., an Received Signal Strength Indication (RSSI) procedure.

Some demonstrative embodiments are described below with respect to FTM measurements according to an FTM procedure. However, other embodiments may be implemented with respect to any other additional or alternative positioning measurements and/or communications, ranging measurements and/or communications, proximity measurements and/or communications, location estimation measurements and/or communications.

In some demonstrative embodiments, wireless communication devices 102 and/or 140 may be configured to perform one or more FTM measurements, for example, using WLAN communications, e.g., WiFi. For example, using WiFi to perform time based range measurements, e.g., FTM measurements, may enable, for example, increasing an indoor location accuracy of the mobile devices, e.g., in an indoor environment.

In some demonstrative embodiments, the FTM measurements may include a round trip time (RTT) measurement (also referred to as Time of Flight (ToF) measurement).

The ToF may be defined as the overall time a signal propagates from a first station, e.g., mobile device, to a second station, e.g., wireless communication device 102, and back to the first station. A distance between the first and second stations may be determined based on the ToF value, for example, by dividing the ToF value by two and multiplying the result by the speed of light.

In some demonstrative embodiments, wireless communication device 102 and/or wireless communication device 140, may be configured to utilize an FTM Protocol, for example, in accordance with the IEEE 802.11REVmc D4.0 Specification, and/or any other specification, standard and/or protocol. For example, wireless communication device 102 and/or wireless communication device 140 may be configured to use the FTM protocol to measure the RTT from wireless communication device 102 to a plurality of other STAs, e.g., including wireless communication device 140, and/or one or more other responder stations.

In some demonstrative embodiments, wireless communication device 102 may include an FTM component 117, and/or wireless communication device 140 may include an FTM component 157, which may be configured to perform one or more FTM measurements, operations and/or communications, e.g., as described below.

In some demonstrative embodiments, FTM components 117 and/or 157 may include, or may be implemented, using suitable circuitry and/or logic, e.g., controller circuitry and/or logic, processor circuitry and/or logic, memory circuitry and/or logic, and/or any other circuitry and/or logic, which may be configured to perform at least part of the functionality of FTM components 117 and/or 157. Additionally or alternatively, one or more functionalities of FTM components 117 and/or 157 may be implemented by logic, which may be executed by a machine and/or one or more processors, e.g., as described below.

In some demonstrative embodiments, FTM component 117 may be configured to perform one or more operations of, and/or at least part of the functionality of, message processor 128 and/or controller 124, for example, to trigger communication of one or more FTM messages, e.g., as described below.

In some demonstrative embodiments, FTM component 157 may be configured to perform one or more operations of, and/or at least part of the functionality of, message processor 158 and/or controller 154, for example, to trigger communication of one or more FTM messages, e.g., as described below.

In some demonstrative embodiments, FTM components 117 and/or 157 may be configured to trigger the FTM measurements, for example, periodically and/or or upon a request from an application executed by another device, for example, to determine an accurate location of the other device, e.g., as described below.

In some demonstrative embodiments, FTM components 117 and/or 157 may be configured to perform one or more measurements according to an FTM protocol, for example, in accordance with an IEEE 802.11 Specification, e.g., an IEEE 802.11RevMC Specification and/or any other specification and/or protocol.

In some demonstrative embodiments, FTM components 117 and/or 157 may be configured to perform one or more proximity, ranging, and/or location estimation measurements, e.g., in an indoor location, based on the FTM measurements. For example, the FTM measurements may provide a relatively accurate estimation of location, range and/or proximity, e.g., in an indoor location.

Some demonstrative embodiments are described herein with respect to an FTM component, e.g., FTM components 117 and/or 157, configured to perform measurements according to an FTM protocol and/or procedure. However, in other embodiments, the FTM component may be configured to perform any other additional or alternative type of Time of Flight (ToF) measurements, ranging measurements, positioning measurements, proximity measurements, and/or location estimation measurements, e.g., according to any additional or alternative protocol and/or procedure.

In some demonstrative embodiments, wireless communication device 102, and/or wireless communication device 140 may be configured to perform one or more FTM measurements, for example between wireless communication device 102 and wireless communication device 140, for example, to determine a location of wireless communication device 102 e.g., as described below.

In some demonstrative embodiments, FTM component 157 may be configured to perform one or more operations of an FTM responder station to perform one or more FTM measurements with one or more mobile devices, e.g., wireless communication device 102.

In some demonstrative embodiments, FTM component 117 may be configured to perform one or more operations of an FTM initiator station to initiate one or more FTM measurements with one or responder stations, e.g., wireless communication device 140 and/or any other responder station, e.g., as described below.

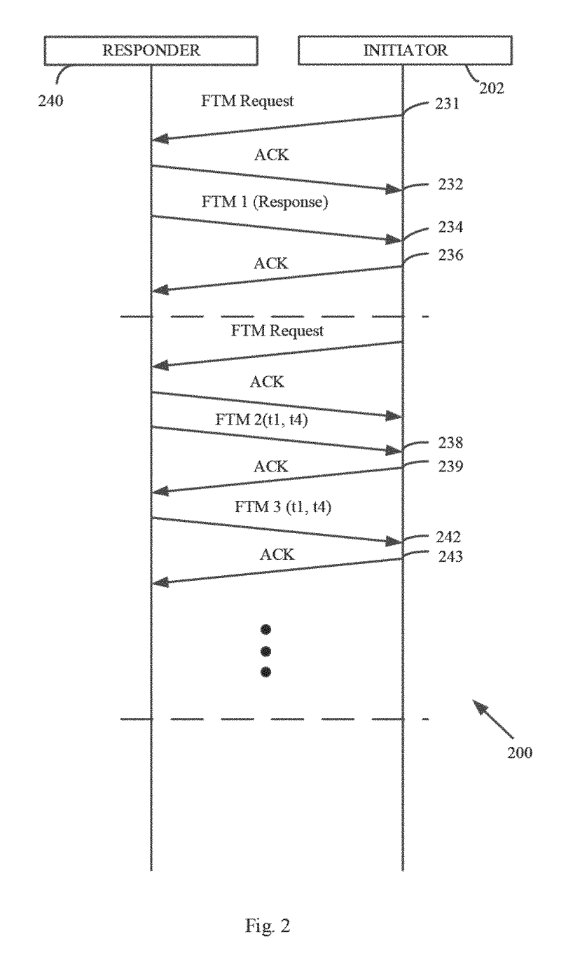

Reference is made to FIG. 2, which schematically illustrates a sequence diagram, which demonstrates operations and interactions between a first wireless communication device 202 (“Initiating STA” or “initiator”) and a second wireless communication device 240 (“Responding STA” or “responder”), of an FTM procedure 200, in accordance with some demonstrative embodiments. In one example, device 102 (FIG. 1) may perform the role of, and/or one or more operations and/or the functionalities of, device 202, and/or device 140 (FIG. 1) may perform the role of, and/or one or more operations and/or the functionalities of, device 240.

As shown in FIG. 2, device 202 may transmit to device 240 an FTM request message 231 to request to perform the FTM procedure 200 with device 240. For example, FTM component 117 (FIG. 1) may trigger, instruct, cause and/or request radio 114 (FIG. 1) to transmit the FTM request message 231, e.g., to wireless communication device 140 (FIG. 1).

As shown in FIG. 2, device 240 may transmit an FTM request acknowledgement (ACK) 232 to device 202, to acknowledge receipt of the FTM request message 231, and to confirm the request to perform the FTM procedure. For example, FTM component 157 (FIG. 1) may trigger, instruct, cause and/or request radio 144 (FIG. 1) to process reception of the FTM request ACK message 232 to wireless communication device 102 (FIG. 1).

As shown in FIG. 2, FTM procedure 200 may include an FTM measurement period, during which devices 202 and 240 may communicate FTM measurement frames, e.g., as described below. For example, FTM component 117 (FIG. 1) may trigger, instruct, cause and/or request radio 114 (FIG. 1) to communicate one or more messages with wireless communication device 140 (FIG. 1) during the FTM measurement period; and/or FTM component 157 (FIG. 1) may trigger, instruct, cause and/or request radio 144 (FIG. 1) to communicate the one or more messages with wireless communication device 102 (FIG. 1) during the FTM measurement period, e.g., as described below.

In some demonstrative embodiments, devices 202 and/or 240 may communicate the FTM measurement frames between devices 202 and 240 during the FTM measurement period, for example, to determine a Time of Flight (ToF) value between devices 202 and 240.

In some demonstrative embodiments, as shown in FIG. 2, device 240 may transmit an FTM message 234 to device 202, at a time, denoted t1. The time t1 may be a Time of Departure (ToD), denoted ToD(M), of message 234.

In some demonstrative embodiments, as shown in FIG. 2, device 202 may receive message 234 and may determine a time, denoted t2, e.g., by determining a Time of Arrival (ToA), denoted ToA(M), of message 234. For example, FTM component 117 (FIG. 1) may be configured to trigger, instruct, cause and/or request radio 114 (FIG. 1) to process receipt of message 234, and/or FTM component 117 (FIG. 1) may be configured to determine the ToA of message 234.

In some demonstrative embodiments, as shown in FIG. 2, device 202 may transmit a message 236 to device 240, at a time, denoted t3. Message 236 may include, for example, an acknowledgement message transmitted in response to FTM message 234. The time t3 may be a ToD, denoted ToD(ACK), of the message 236. For example, FTM component 117 (FIG. 1) may be configured to trigger, instruct, cause and/or request radio 114 (FIG. 1) to transmit message 236, and/or FTM component 117 (FIG. 1) may be configured to determine the ToD of message 236.

In some demonstrative embodiments, as shown in FIG. 2, device 240 may receive message 236 and may determine a time, denoted t4, e.g., by determining a ToA, denoted ToA(ACK), of message 236. For example, FTM component 157 (FIG. 1) may be configured to trigger, instruct, cause and/or request radio 144 (FIG. 1) to receive message 236, and/or FTM component 157 (FIG. 1) may be configured to determine the ToA of message 236.

In some demonstrative embodiments, as shown in FIG. 2, device 240 may transmit an FTM message 238 to device 202. Message 238 may include, for example, information corresponding to the time t1 and/or the time t4. For example, message 238 may include a timestamp, e.g., a ToD timestamp, including the time t1, and a timestamp, e.g., a ToA timestamp, including the time t4. For example, FTM component 157 (FIG. 1) may be configured to trigger, instruct, cause and/or request radio 144 (FIG. 1) to transmit message 238.

In some demonstrative embodiments, as shown in FIG. 2, device 202 may receive message 238. For example, FTM component 117 (FIG. 1) may be configured to trigger, instruct, cause and/or request radio 114 (FIG. 1) to process receipt of message 238, and/or FTM component 117 (FIG. 1) may be configured to access, extract and/or process the information corresponding to the time t1 and/or the time t4.

In some demonstrative embodiments, as shown in FIG. 2, device 202 may transmit a message 239 to device 240. Message 239 may include, for example, an acknowledgement message transmitted in response to message 238. For example, FTM component 117 (FIG. 1) may be configured to trigger, instruct, cause and/or request radio 114 (FIG. 1) to transmit message 239.

In some demonstrative embodiments, as shown in FIG. 2, device 240 may transmit an FTM message 242 to device 202. Message 242 may include, for example, information corresponding to the time value t1 and/or the time value t4, e.g., corresponding to the messages 238 and 239. For example, message 242 may include a timestamp, e.g., a ToD timestamp, including the time value t1 corresponding to the message 238, and a timestamp, e.g., a ToA timestamp, including the time value t4 corresponding to message 239. For example, FTM component 157 (FIG. 1) may be configured to trigger, instruct, cause and/or request radio 114 (FIG. 1) to receive message 242.

In some demonstrative embodiments, as shown in FIG. 2, device 202 may receive message 242. For example, FTM component 117 (FIG. 1) may be configured to trigger, instruct, cause and/or request radio 114 (FIG. 1) to process receipt of message 242, and/or FTM component 117 (FIG. 1) may be configured to access, extract and/or process the information corresponding to the time t1 and/or the time t4.

In some demonstrative embodiments, as shown in FIG. 2, device 202 may transmit a message 243 to device 240. Message 239 may include, for example, an acknowledgement message transmitted in response to message 242. For example, FTM component 117 (FIG. 1) may be configured to trigger, instruct, cause and/or request radio 114 (FIG. 1) to transmit message 243.

In some demonstrative embodiments, device 202 may determine a ToF between device 202 and device 240, for example, based on message 238 and/or message 242. For example, FTM component 117 (FIG. 1) may be configured determine the ToF, e.g., as described below.

For example, device 202 may determine the ToF based on an average, or any other function, applied to the time values t1, t2, t3 and t4. For example, device 202 may determine the ToF, e.g., as follows:

ToF=[(t4−t1)−(t3−t2)]/2 (1)

In some demonstrative embodiments, device 202 may determine the distance between devices 202 and 240 based on the calculated ToF.

For example, device 202 may determine the distance, denoted rₖ, e.g., as follows:

rₖ=ToF*C (2)

wherein C denotes the radio wave propagation speed.

Referring back to FIG. 1, device 102 may determine a location of device 102, e.g., an absolute location of device 102, for example, based on the estimated range rk, e.g., as described below.

For example, device 102 may determine two or more ToF values and/or range values, e.g., according to Equations 1 and/or 2, with respect to two or more respective other devices, e.g., at least three or four other devices, and may determine the location of device 102 based on the two or more ToF values, for example, by trilateration.

In some demonstrative embodiments, devices 102 and/or 140 may communicate any other messages, e.g., in addition to or instead of FTM messages, for example, to determine the location of device 102.

In some demonstrative embodiments, location based technologies, e.g., WiFi-Based Location technologies, for example, FTM measurements and/or RSSI-based measurements, may require knowledge of a location of a responder station, e.g., wireless communication device 140, for example, to produce a self-location of a device, e.g., device 102, for example, after the FTM was performed, and/or ranges to the responder station were calculated.

In some demonstrative embodiments, device 140 may perform the functionality of a location responder station, e.g., as described above.

In some demonstrative embodiments, device 102 may perform the functionality of a location initiator station, e.g., as described above.

In some demonstrative embodiments, devices 102 and 140 may communicate according to a STA to AP scheme, wherein device 102 may perform the role of a non-AP STA, and device 140 may perform the role of an AP STA.

In some demonstrative embodiments, devices 102 and 140 may communicate according to a STA to STA scheme or a P2P scheme, wherein devices 102 and 10 may perform the roles of non-AP STAs, and/or P2P STAs.

In some demonstrative embodiments, wireless communication device 102 and/or wireless communication device 140 may perform the functionality of a Machine to Machine (M2M) station.

In some demonstrative embodiments, wireless communication device 102 and/or wireless communication device 140 may perform the functionality of an IoT station.

In some demonstrative embodiments, wireless communication device 102 and/or wireless communication device 140 may perform the functionality of a vehicular station.

In some demonstrative embodiments, devices 102 and device 140 may include mobile or non-static devices, which may move and/or dynamically change locations.

In one example, devices 102 and 140 may include, or implemented as part of, vehicular devices, M2M stations, autonomous or self-guided vehicles, e.g., cars or drones, which may utilize FTM measurements as part of Machine-type-communication (MTC).

In some demonstrative embodiments, device 102 may perform several range measurements with different responding stations, e.g., 3 or 4, and the position of the different responding stations, for example, to determine the location of device 102, e.g., as described above.

In some demonstrative embodiments, one or more of the responding stations may be non-static (“dynamic responders”), e.g., in dynamic movement.

In some demonstrative embodiments, device 140 may be configured to send, e.g., to device 102, position-based information corresponding to a change in position of device 140, for example, at least to assist device 102 in a location estimation procedure based on a ranging measurement with device 104, e.g., as described below.

In some demonstrative embodiments, the position-based information corresponding to the change in the position of device 140 may include, for example, sensor-based position information sensed by one or more sensors of device 140, e.g., as described below.

In some demonstrative embodiments, the position-based information corresponding to the change in the position of device 140 may include information of a displacement of device 140, a speed vector corresponding to a speed of device 140, an acceleration of device 140, and/or any information of any change position and/or motion sensor of device 140, e.g., as described below.

In some demonstrative embodiments, providing to device 102 the position-based information corresponding to the change in the position of device 140 may allow increasing an accuracy of determining the location of device 102, for example, when using position estimation algorithms, e.g., trilateration and/or Kalman filter.

In some demonstrative embodiments, device 102 may utilize information regarding a movement of a dynamic responder, e.g., device 140, for example, to perform the trilateration, e.g., to solve one or more trilateration equations.

In one example, device 102 may utilize information regarding a movement of a dynamic responder, e.g., device 140, for example, even in a case where device 140 is the only available responder device, or if a count of static responder stations is not enough to estimate allocation of device 102.

In some demonstrative embodiments, usage of the movement information corresponding to device 140 may be dependent on a positioning algorithm, which may be used to determine the location of device 102, however, the movement information may potentially improve accuracy of various types of, or even all, positioning algorithms.

In one example, errors of the position-based information may have minimal correlation with errors of FTM measurements, e.g., since the sensor measurements and FTM measurements may use different methods. Therefore, the position-based information may enable to reduce a position estimation error of the position estimation algorithms.

In some demonstrative embodiments, the position-based information corresponding to the change in the position of device 140 may provide additional information to device 102, for example, to enable device 102 to estimate the location of device 102. For example, device 102 may be able to eliminate possible solution hypothesis, Bayesian filter and/or the like, and/or to better estimate an actual location of a dynamic station, e.g., to be considered in trilateration and/or positioning equations.

In some demonstrative embodiments, position-based information of one or more dynamic stations may provide additional information to device 102, for example, in environments and/or scenarios in which a number of stationery responding stations is not enough to provide an accurate estimation of a location of a mobile station. For example, the position-based information of the dynamic responders may assist device 102 in determining an accurate location of device 102, e.g., using trilateration.

In some demonstrative embodiments, device 140 may be configured to report to device 102 the position-based information corresponding to device 140, for example, to enable device 102 to estimate the location of device 102, e.g., as described below.

In some demonstrative embodiments, device 140 may be configured to report to the position-based information corresponding to the change in the position of device 140 to another device, e.g., an external LCI requester, a network manager and/or the like, for example, to enable the other device to estimate a future location of device 140, and/or a relevance of the report, for example, after a predefined period of time, e.g., as described below.

In some demonstrative embodiments, communicating the position-based information corresponding to device 140 to device 102 may be utilized to reduce a number of FTM measurements performed in time, for example, by adjusting, e.g., decreasing, a periodicity of FTM measurements.

In some demonstrative embodiments, reducing the periodicity of FTM measurements may significantly reduce a medium usage.

In some demonstrative embodiments, devices 102 and/or 140 may be configured to utilize communication of the position-based information corresponding to device 140, for example, to improve a WiFi ToF and/or an FTM-based position estimation accuracy, e.g., as described below.

In some demonstrative embodiments, device 140 may be configured to provide sensor-based position information to device 102, for example, to enable device 102 to improve the position estimation accuracy of a location of device 102, e.g., as described below.

In some demonstrative embodiments, the sensor-based position information corresponding to device 140 may include, for example, a position displacement of device 140 since a last measurement, e.g., delta-X, delta-Y, delta-Z, and an estimated error of the position displacement, e.g., as described below.

In some demonstrative embodiments, the sensor-based position information corresponding to device 140 may include, for example, a speed vector corresponding to a speed of device 140, e.g., dX, dY, dZ, and an estimated error of the speed vector, e.g., as described below.

In some demonstrative embodiments, the sensor-based information corresponding to device 140 may include, for example, accelerometer information, for example, nine-axis accelerometer information, e.g., 3-axis compass information, 3-axis gyroscope information, and/or 3-axis accelerator information, and an estimated error of the nine-axis accelerometer information, e.g., as described below.

In some demonstrative embodiments, the sensor-based information corresponding to device 140 may include, for example, six degree of freedom (6DoF) motion-sensor information, e.g., including at least pitch, yaw and/or roll information corresponding to a pitch, a yaw and/or a roll of device 140, and an estimated error of the 6FoF motion-sensor information, e.g., as described below.

In some demonstrative embodiments, device 140 may include one or more sensors 160 configured to provide the sensor-based position information corresponding to a change in a position of device 140.

In some demonstrative embodiments, sensors 160 may include, for example, a barometer, a compass, an accelerometer, a gyroscope, a Micro electro-mechanical systems (MEMS) sensor, one or more inertial sensors (INS), a speedometer, a motion sensor, a 6DoF sensor, a 9-axis MEMS sensor, a location determination mechanism or algorithm, and/or any other movement detector configured to detect movement and/or a change in a position of device 140.

In some demonstrative embodiments, errors of one or more sensor measurements performed by sensors 160 may have reduced, or even minimal, correlation with FTM measurements performed between devices 102 and 140, for example, since the sensor measurements and FTM measurements may use different measurement methods. Accordingly, the sensor-based position information provided by device 140 may be utilized to reduce a position estimation error based on FTM measurements between device 102 and device 140.

In some demonstrative embodiments, device 102 may perform a ToF measurement with a dynamic device, e.g., device 140, for example, to estimate a location of device 102.

In one example, device 140 may move from a first position, e.g., a first location and/or orientation, to a second position, e.g., a second location and/or orientation, for example, during the FTM measurements.

In some demonstrative embodiments, device 140 may be configured to provide to device 102 position based information corresponding to the change in the position of device 140, e.g., from the first position to the second position, as described below.

In some demonstrative embodiments, FTM component 117 may be configured to trigger, control, instruct, cause and/or request wireless communication device 102 and/or transmitter 118 to transmit to device 140 a request 123 for sensor-based position information corresponding to a change in a position of device 140.

In some demonstrative embodiments, device 140 may receive from device 102 the request 123 for sensor-based position information corresponding to the change in the position of device 140.

In some demonstrative embodiments, FTM component 157 may be configured to trigger, control, instruct, cause and/or request wireless communication device 140 and/or receiver 146 to process reception of request 123 for the sensor-based position information corresponding to the change in the position of device 140.

In some demonstrative embodiments, FTM component 157 may be configured to trigger, control, instruct, cause and/or request wireless communication device 140 to process and/or determine the sensor-based position information corresponding to device 140, for example, based on sensor measurements from one or more sensors 160.

In some demonstrative embodiments, FTM component 157 may be configured to trigger, control, instruct, cause and/or request wireless communication device 140 and/or transmitter 148 to transmit to wireless communication device 102 a response 143 including the sensor-based position information corresponding to device 140.

In some demonstrative embodiments, device 102 may receive response 143 including the sensor-based position information from device 140.

In some demonstrative embodiments, FTM component 117 may be configured to trigger, control, instruct, cause and/or request wireless communication device 102, and/or receiver 116 to process the response 143 including the sensor-based position information corresponding to the change in the position of device 140.

In some demonstrative embodiments, FTM component 117 may be configured to trigger, control, instruct, cause and/or request wireless communication device 102 to estimate a location of device 102, for example, based at least on a ToF measurement between device 102 and device 140, and the sensor-based position information corresponding to the change in the position of device 140.

In some demonstrative embodiments, the sensor-based position information may indicate, for example, a change in at least one of a location of device 140, and/or a change in an orientation of device 140, e.g., as described below

In some demonstrative embodiments, the sensor-based position information corresponding to the change in the position of device 140 may be represented in at least three axes, e.g., as described below.

In some demonstrative embodiments, the sensor-based position information may include, for example, at least one value corresponding to the change in the position of device 140, and an estimated error of the at least one value corresponding to the change in the position of device 140, e.g., as described below.

In some demonstrative embodiments, the sensor-based position information may include, for example, at least displacement information corresponding to a displacement of device 140 relative to a previous position of device 140, e.g., when providing previous position information.

In some demonstrative embodiments, the displacement information may include, for example, 3-axis displacement coordinates, e.g., in the form of delta-X, delta-Y, and delta-Z displacement values.

In some demonstrative embodiments, the displacement information may include, for example, at least one value corresponding to the change in the position of device 140, and an estimated error of the at least one value corresponding to the change in the position of device 140.

In some demonstrative embodiments, the displacement information may include, for example, an estimated error of one or more values of the displacement coordinates, e.g., a delta-X displacement error, a delta-Y displacement error, and/or a delta-Z displacement error.

In one example, the displacement information may include, for example, 3-axis displacement coordinates representing a change between first coordinates of device 140 at a first location and second coordinates of device 140 at a second location. For example, the first location may have the coordinates (1, 3, 5) and the second location may have the coordinates (5, 7, −5). According to this example, the displacement information may include the displacement coordinates (4, 4, −10), e.g., (1, 3, 5)-(5, 7, −5).

In another example, the displacement information may be derived from measurements of an inertial measurement unit (IMU) and/or an inertial navigation system (INS), for example, in the form of relative displacement information.

In some demonstrative embodiments, the sensor-based position information corresponding to device 140 may include, for example, at least velocity information corresponding to a velocity of device 140.

In some demonstrative embodiments, the velocity information may include, for example, at least one value (“velocity value”) corresponding to the velocity of device 140, and an estimated error of the at least one velocity value.

In some demonstrative embodiments, the velocity information may include, for example, a 3-axis velocity vector, e.g., including a dX velocity, a dY velocity, and/or a dZ velocity.

In some demonstrative embodiments, the velocity information may include, for example, an estimated error of one or more values of the velocity vector, e.g., a dX velocity error, a dY velocity error, and/or a dZ velocity error.

In some demonstrative embodiments, the sensor-based position information corresponding to device 140 may include, for example, at least multi-axis accelerometer information corresponding to device 140.

In some demonstrative embodiments, the multi-axis accelerometer information may include, for example, 9-axis information, e.g., 3-axis compass information, 3-axis gyroscope information, and/or 3-axis accelerator information. In other embodiments, the multi-axis accelerometer information may include accelerometer information corresponding to any other number of axes, e.g., less than 9 axes or more than 9 axes, according to any suitable axis system.

In some demonstrative embodiments, the multi-axis accelerometer information may include, for example, at least one estimated error corresponding to the one or more values of the multi-axis information, e.g., one or more error values of the 3-axis compass information, one or more error values 3-axis gyroscope information, and/or one or more error values of the 3-axis accelerator information.

In some demonstrative embodiments, the sensor-based position information corresponding to device 140 may include, for example, at least six degrees of freedom (6DOF) information corresponding to an orientation of device 140.

In some demonstrative embodiments, the 6DOF information may include information, for example, pitch orientation information, yaw orientation information and/or roll orientation information, corresponding to a pitch, a yaw and/or a roll of device 140.

In some demonstrative embodiments, the 6DOF information may include, for example, at least one estimated error corresponding to the pitch orientation, the yaw orientation, and/or the roll orientation.

In some demonstrative embodiments, the sensor-based position information corresponding to device 140 may be utilized, e.g., by device 102 and/or any other device or entity, e.g., a network entity, for example to improve WiFi ToF/FTM-based position estimation accuracy, e.g., as described above. For example, the sensor-based position information may be useful in environments and/or deployments and/or scenarios including dynamic responders, e.g., cars, drones, and/or IOT devices.

In some demonstrative embodiments, device 140 may be configured to transmit the sensor-based position information to device 102 in one or more FTM messages, for example, as part of an FTM procedure with device 102, e.g., as described below.

In some demonstrative embodiments, the sensor-based position information may be included as part of one or more FTM protocol messages, e.g., as part of FTM messages of the FTM procedure, e.g., FTM procedure 200 (FIG. 2).

In some demonstrative embodiments, device 140 may be configured to transmit to device 102 an FTM message, e.g., an FTM, response, including the sensor-based position information corresponding to device 140, and one or more timing values of a ToF measurement, e.g., as described below.

In some demonstrative embodiments, device 140 may be configured to transmit the sensor-based position information corresponding to device 140 as part of a Location Configuration Information (LCI) message, e.g., as described below.

In other embodiments, device 140 may be configured to transmit the sensor-based position information corresponding to device 140 as part of any other additional or alternative type of message and/or Information Element (IE).

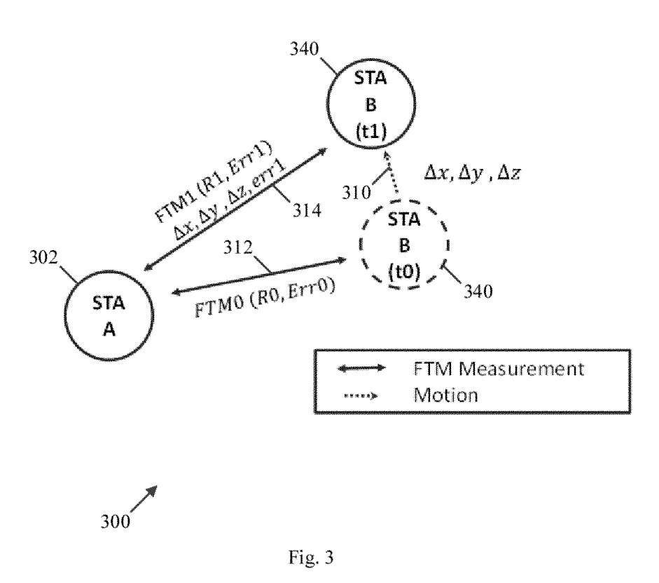

Reference is made to FIG. 3, which schematically illustrates a measurement scheme 300 of FTM measurements between a first wireless communication device 302, denoted STA A, (“Initiating STA” or “initiator”) and a second wireless communication device 340, denoted STA B, (“Responding STA” or “responder”), in accordance with some demonstrative embodiments. In one example, device 102 (FIG. 1) may perform the role of, and/or one or more operations and/or the functionalities of, device 302, and/or device 140 (FIG. 1) may perform the role of, and/or one or more operations and/or the functionalities of, device 340.

In some demonstrative embodiments, as shown in FIG. 3, device 302 remain static, while device 340 may move (310) from a first location, e.g., at time denoted t0, to a second location, e.g., at time denoted t1.

In some demonstrative embodiments, as shown in FIG. 3, devices 302 and 340 may perform an FTM measurement 312, e.g., at time t0, for example, to determine a range between devices 302 and 340.

In some demonstrative embodiments, as shown in FIG. 3, FTM measurement 312 may include range information, denoted R0, corresponding to a range between devices 302 and 340 at the first location, and an estimated error, denoted Err0, of the range information R0. For example, the range information R0 and/or the error Err0 may include FTM measurement values, e.g., as described above with reference to FIG. 2.

In some demonstrative embodiments, as shown in FIG. 3, devices 302 and 340 perform an FTM measurement 314, for example, to determine a range between devices 302 and 340, e.g., at the time t1.

In some demonstrative embodiments, as shown in FIG. 3, FTM measurement 314 may include range information, denoted R1, corresponding to a range between devices 302 and 340 at the second location, and an estimated error, denoted Err1, of the range information R1. For example, the range information R1 and/or the error Err1 may include FTM measurement values, e.g., as described above with reference to FIG. 2.

In some demonstrative embodiments, as shown in FIG. 3, FTM measurement 314 may include communication of sensor-based location information corresponding to the change in the position of device 340 from the first location to the second location, for example, in an FTM response message of FTM measurement 314. For example, device 340 may transmit to device 302 an FTM response message FTM measurement 314 including the sensor-based location information corresponding to the change in the position of device 340.

In some demonstrative embodiments, as shown in FIG. 3, the sensor-based location information may include displacement information, denoted Δx, Δy, Δz, corresponding to a displacement of device 340 at the second location relative to the first location.

In some demonstrative embodiments, as shown in FIG. 3, the sensor-based location information may include an estimated error, denoted errl, of the displacement information.

In some demonstrative embodiments, device 302 may utilize the range information of FTM measurement 314 and the sensor-based location information corresponding to the displacement of device 340 relative to the first location, for example, to estimate the location of device 302, e.g., more accurately.

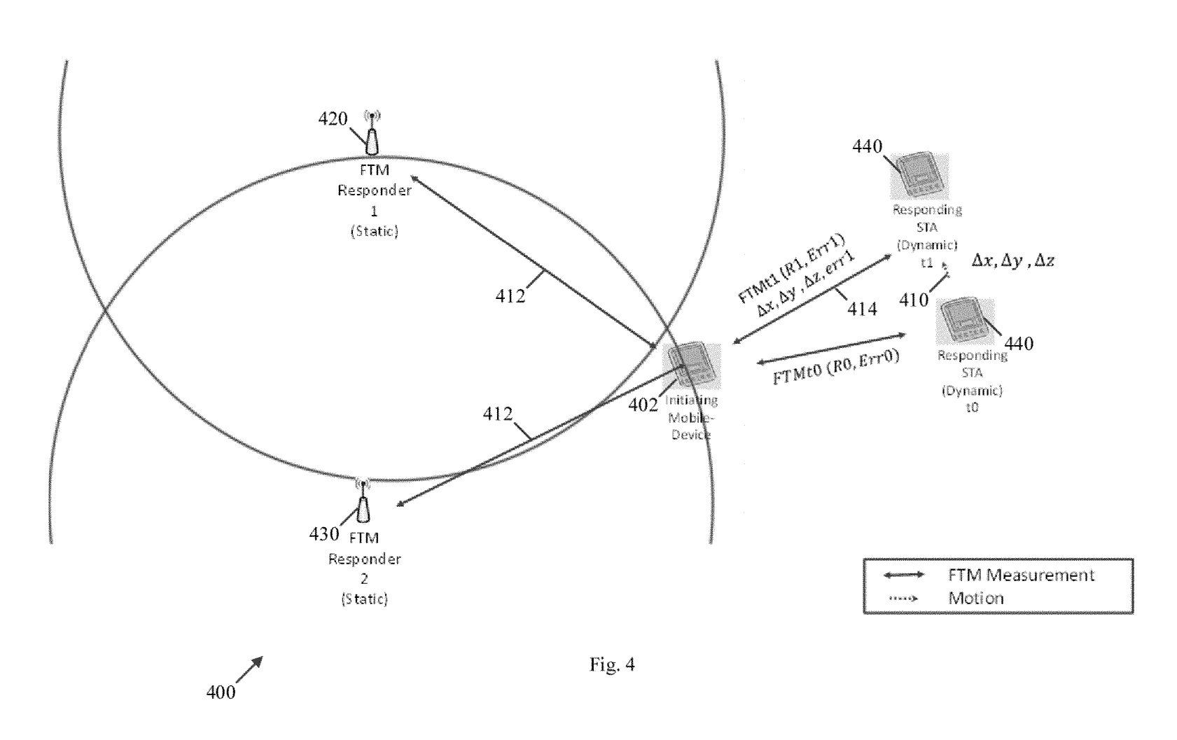

Reference is made to FIG. 4, which schematically illustrates a location estimation of a mobile device 402 in a deployment 400 including a mobile responding station, in accordance with some demonstrative embodiments. In one example, device wireless communication device 102 (FIG. 1) may be configured to operate as, perform the role of, and/or perform one or more functionalities of, device 402.

In some demonstrative embodiments, as shown in FIG. 4, deployment 400 may include a first static FTM responder 420, a second static FTM responder 430, and a dynamic responder station 440. For example, wireless communication device 140 (FIG. 1) may be configured to operate as, perform the role of, and/or perform one or more functionalities of, dynamic responder STA 440.

In some demonstrative embodiments, as shown in FIG. 4, responder 440 may move (410) from a first location, e.g., at time denoted t0, to a second location, e.g., at time denoted t1.

In some demonstrative embodiments, FTM measurements 412 between device 402 and static FTM responders 420 and 430 may provide limited ranging information, which may not enable to accurately estimate a location of device 402.

In some demonstrative embodiments, as shown in FIG. 4, device 402 may perform FTM measurements with device 440, e.g., as described above with reference to FIG. 3.

In some demonstrative embodiments, as shown in FIG. 4, device 402 may perform an FTM measurements 414 with responder 440, during which responder 440 may transmit to device 402 the sensor-based position information corresponding to responder 440, for example, in an FTM response message of FTM measurement 414.

In some demonstrative embodiments, the sensor-based position information may assist device 402 in estimating the location of device 402.

For example, device 402 may utilize the range information of FTM measurement 414, the sensor-based location information corresponding to the displacement of device 440, and the limited ranging information from static responders 430 and 420, for example, to estimate the location of device 402, e.g., more accurately.

Referring back to FIG. 1, in some demonstrative embodiments, devices 102 and/or 140 may be configured to generate, transmit, receive, and/or process one or more FTM messages including sensor-based position information, e.g., as described below.

In some demonstrative embodiments, request 123 may include an FTM request, e.g., FTM request message 231 (FIG. 2), and/or response 143 may include an FTM response, e.g., FTM messages 234 or 238 (FIG. 2).

In some demonstrative embodiments, FTM component 117 may be configured to trigger, control, instruct, cause and/or request wireless communication device 102 and/or transmitter 118 to transmit to device 140 an FTM request including a request for sensor-based position information. For example, device 102 may transmit FTM request message 231 (FIG. 2) to device 140 including the request for sensor-based position information.

In some demonstrative embodiments, FTM component 157 may be configured to trigger, control, instruct, cause and/or request wireless communication device 140 and/or receiver 146 to process the FTM request from device 102 including the request for sensor-based position information.

In some demonstrative embodiments, FTM component 157 may be configured to trigger, control, instruct, cause and/or request wireless communication device 140 and/or transmitter 148 to transmit to device 102 an FTM response including the sensor-based position information corresponding to device 140, and one or more timing values of a ToF measurement. For example, device 140 may transmit FTM message 238 (FIG. 2) including the sensor-based position information and the timing values, e.g., the time values t1 and/or t4.

In some demonstrative embodiments, FTM component 117 may be configured to trigger, control, instruct, cause and/or request wireless communication device 102 and/or receiver 116 to process the FTM response from device 140 including the sensor-based position information and the one or more timing values of the ToF measurement.

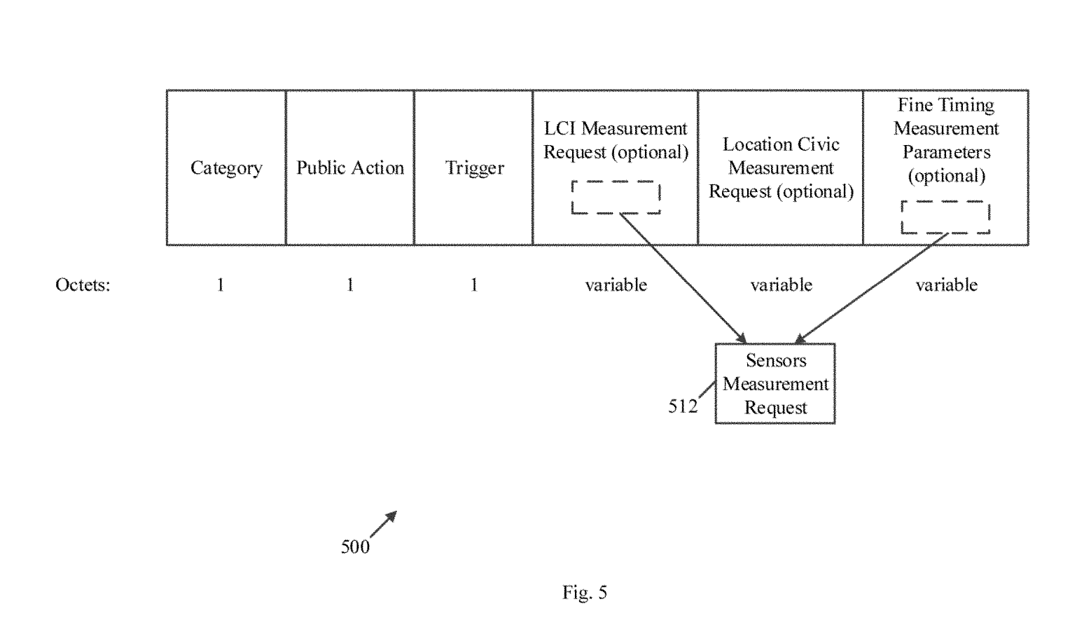

Reference is made to FIG. 5, which schematically illustrates an action field 500 of an FTM request frame, in accordance with some demonstrative embodiments. For example, device 102 (FIG. 1) may be configured to transit to device 140 (FIG. 1) an FTM request frame including action field 500, and/or device 140 (FIG. 1) may be configured to process the FTM request frame from device 102 (FIG. 1) including action field 500.

In some demonstrative embodiments, action field 500 may be configured to include a request for sensor-based position information, e.g., as described below.

In some demonstrative embodiments, as shown in FIG. 5, an information element (IE) 512, denoted “Sensors Measurement Request” including the request for sensor-based position information, may be added to action field 500. For example, IE 512 may be implemented in the form of an optional flag element.

In some demonstrative embodiments, as shown in FIG. 5, the IE 512 including the sensor-based position information, may be included, for example, as part of an LCI request field 510, or an FTM parameters field 520 of the action field 500. In other embodiments, the IE 512 including the request for sensor-based position information may be included in any other subelement and/or field of action frame 500.

In one example, request 123 (FIG. 1) may include FTM request 231 (FIG. 2), which may include action field 500 including information element IE 512 to signal the request for the sensor-based position information.

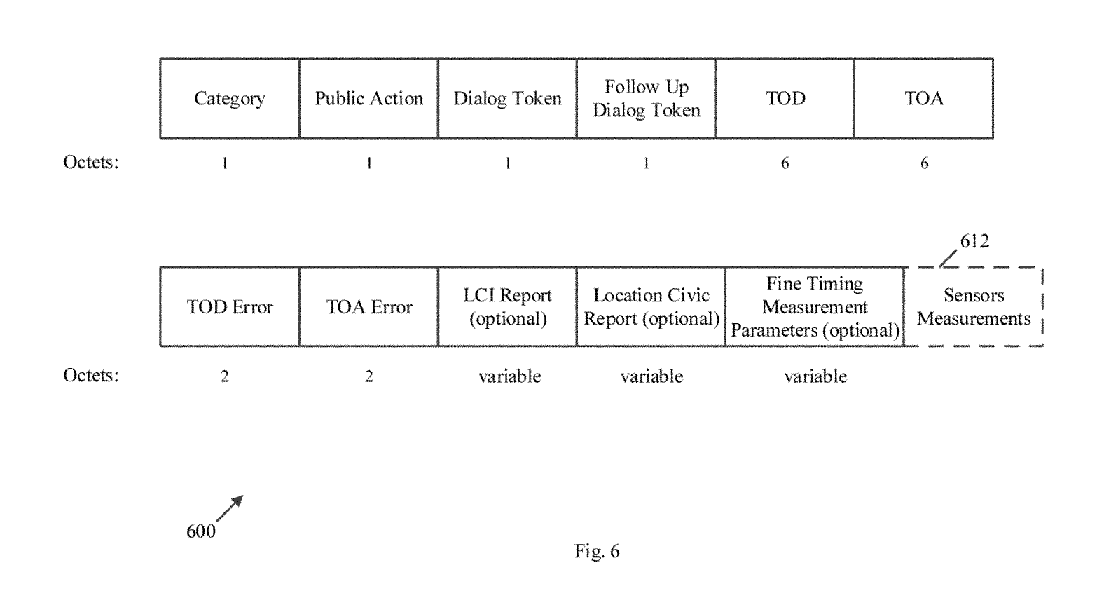

Reference is made to FIG. 6, which schematically illustrates an action field 600 of an FTM frame, in accordance with some demonstrative embodiments. For example, device 140 (FIG. 1) may be configured to transit to device 102 (FIG. 1) an FTM frame including action field 600, and/or device 102 (FIG. 1) may be configured to process the FTM frame from device 140 (FIG. 1) including action field 600.

In some demonstrative embodiments, action field 600 may be configured to include sensor-based position information corresponding to a sender of the FTM frame including action field 600, e.g., as described below.

In some demonstrative embodiments, as shown in FIG. 6, a sub element 612, demoted “Sensor Measurements”, including the sensor-based position information, may be included in action field 600, for example, as an extension of action field and/or as a dedicated element of action field 600. In other embodiments, the subelement 612 including the sensor-based position information may be included in any other subelement and/or field of action frame 600.

In one example, response 143 (FIG. 1) may include FTM message 238 (FIG. 2), which may include action field 600 to signal the sensor-based position information of device 140 (FIG. 1), e.g., in sub element 612.

Referring back to FIG. 1, in some demonstrative embodiments, devices 102 and/or 140 may be configured to generate, transmit, receive, and/or process one or more LCI messages including sensor-based position information, e.g., as described below.

In some demonstrative embodiments, FTM component 117 may be configured to trigger, control, instruct, cause and/or request wireless communication device 102 and/or transmitter 118 to transmit to device 140 an LCI request including the request for sensor-based position information corresponding to device 140.

In some demonstrative embodiments, FTM component 157 may be configured to trigger, control, instruct, cause and/or request wireless communication device 140 and/or receiver 146 to process the LCI request including the request for sensor-based position information of device 140.

In some demonstrative embodiments, FTM component 157 may be configured to trigger, control, instruct, cause and/or request wireless communication device 140 and/or transmitter 148 to transmit an LCI response including the sensor-based position information corresponding to device 140. For example, device 140 may transmit an LCI response including the sensor-based position information corresponding to device 140.

In some demonstrative embodiments, FTM component 117 may be configured to trigger, control, instruct, cause and/or request wireless communication device 102 and/or receiver 116 to process the LCI response including the sensor-based position information.

In one example, the LCI response may be utilized by a station (“the reporting station”), e.g., device 140, to report sensor-based position information of the reporting station, e.g., upon request from one or more entities, e.g., as described below.

In some demonstrative embodiments, another station and/or a network entity, for example, a network manager and/or the like, may be configured to utilize the report sensor-based position information of the reporting station, for example, to estimate a future location of the reporting station, and/or to estimate a relevance and/or a validity of a measurement report from the reporting station, e.g., after a period of time has passed.

In some demonstrative embodiments, the reporting station may report sensor-based position information in the LCI response, for example, even if a location of the reporting station is unknown.

In some demonstrative embodiments, the sensor-based position information of the reporting station may be utilized, for example, at least to reduce a number of FTM measurements performed in time, for example, by using the sensor-based position information to determine a periodicity of FTM measurements. Reducing the number of FTM measurements may significantly reduce a medium usage, which is a key target of wireless protocols.

In some demonstrative embodiments, a station, e.g., device 140, may utilize an LCI message to report the sensor-based position information, e.g., in addition to reporting a location of the station.

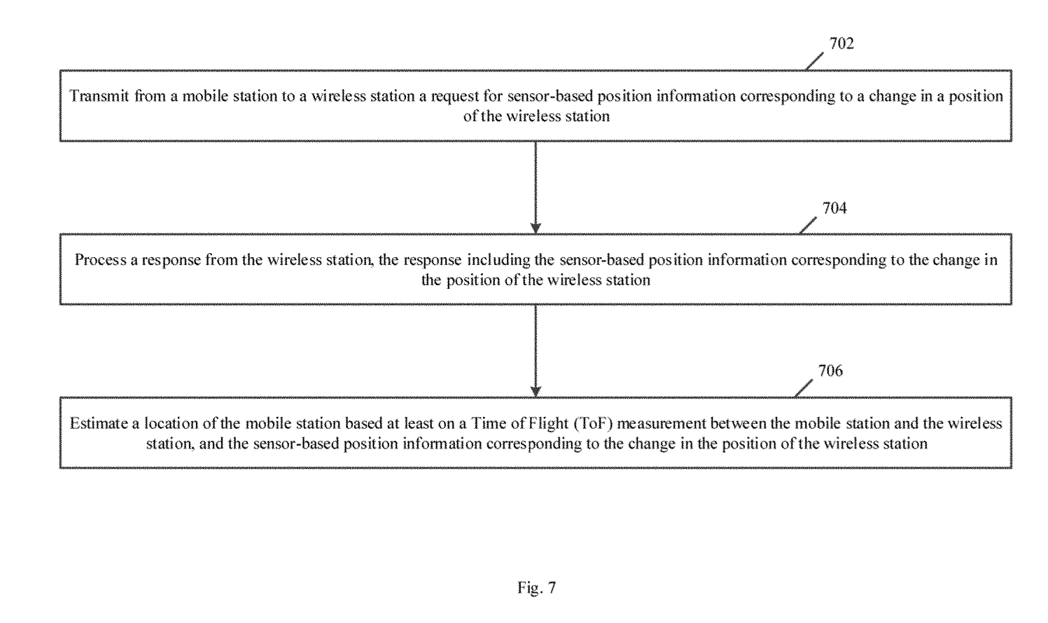

Reference is made to FIG. 7, which schematically illustrates a method of estimating a location of a mobile device, in accordance with some demonstrative embodiments. For example, one or more of the operations of the method of FIG. 7 may be performed by one or more elements of a wireless communication system, e.g., system 100 (FIG. 1); a mobile station, e.g., wireless communication device 102 (FIG. 1); a controller, e.g., controller 124 (FIG. 1); an FTM component, e.g., FTM component 117 (FIG. 1); a radio, e.g., radio 114 (FIG. 1); a message processor, e.g., message processor 128; a transmitter, e.g., transmitter 118 (FIG. 1); and/or a receiver, e.g., receiver 116 (FIG. 1).

As indicated at block 702, the method may include transmitting from a mobile station to a wireless station a request for sensor-based position information corresponding to a change in a position of the wireless station. For example, wireless communication device 102 (FIG. 1) may transmit to wireless communication device 140 (FIG. 1) the request 123 (FIG. 1) including the request for sensor-based position information, e.g., as described above.

As indicated at block 704, the method may include processing a response from the wireless station, the response including the sensor-based position information corresponding to the change in the position of the wireless station. For example, wireless communication device 102 (FIG. 1) may process response 143 (FIG. 1) from wireless communication device 140 (FIG. 1) including the sensor-based position information corresponding to the change in the position of device 140 (FIG. 1), e.g., as described above.

As indicated at block 706, the method may include estimating a location of the mobile station based on a ToF measurement between the mobile station and the wireless station, and the sensor-based position information corresponding to the change in the position of the wireless station. For example, FTM component 117 (FIG. 1) may be configured to trigger, control, instruct, cause and/or request wireless communication device 102 (FIG. 1) to estimate the location of wireless communication device 102 (FIG. 1), for example, based on a ToF measurement between device 102 (FIG. 1) and device 140 (FIG. 1), and the sensor-based position information corresponding to the change in the position of the wireless station wireless communication device 140 (FIG. 1), e.g., as described above.

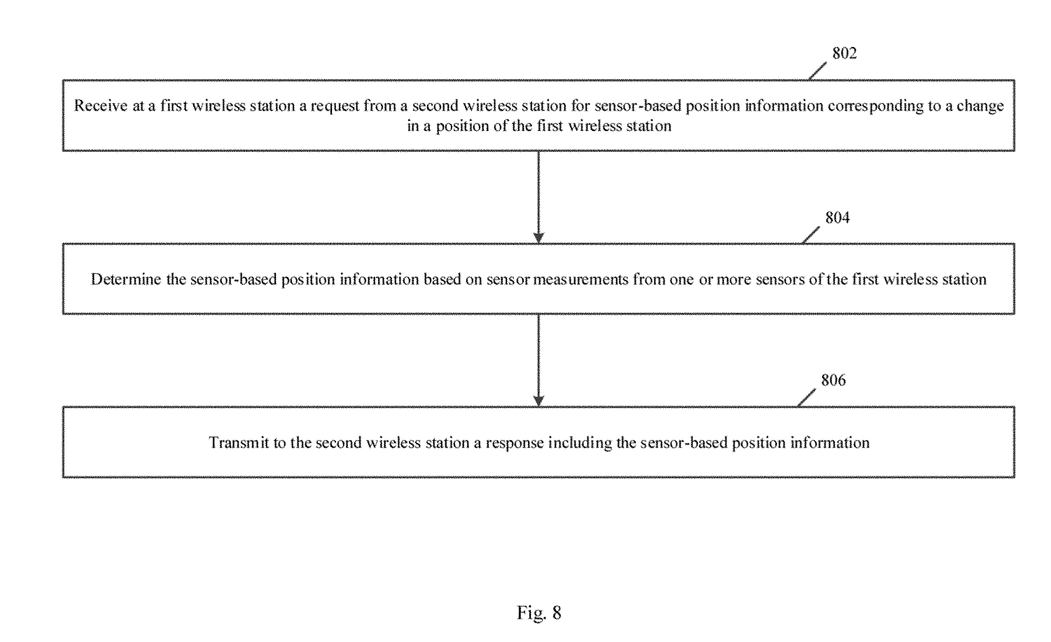

Reference is made to FIG. 8, which schematically illustrates a method of communicating sensor-based position information, in accordance with some demonstrative embodiments. For example, one or more of the operations of the method of FIG. 8 may be performed by one or more elements of a wireless communication system, e.g., system 100 (FIG. 1); a responder station or a wireless station, e.g., wireless communication device 140 (FIG. 1); a controller, e.g., controller 154 (FIG. 1); an FTM component, e.g., FTM component 157 (FIG. 1); a radio, e.g., radio 144 (FIG. 1); a message processor, e.g., message processor 158; a transmitter, e.g., transmitter 148 (FIG. 1); and/or a receiver, e.g., receiver 146 (FIG. 1).

As indicated at block 802, the method may include processing at a first station a request from a second station for sensor-based position information corresponding to a change in a position of the first wireless station. For example, wireless communication device 140 (FIG. 1) may process request 123 (FIG. 1) from wireless communication device 102 (FIG. 1), the request 123 (FIG. 1) including the request for sensor-based position information, e.g., as described above.

As indicated at block 804, the method may include determining the sensor-based position information based on sensor measurements from one or more sensors of the first wireless station. For example, FTM component 157 (FIG. 1) may be configured to trigger, control, instruct, cause and/or request wireless communication device 140 (FIG. 1) to determine the sensor-based position information based on sensor measurements from one or more sensors 160 (FIG. 1), e.g., as described above.

As indicated at block 806, the method may include transmitting to the second wireless station a response including the sensor-based position information. For example, wireless communication device 140 (FIG. 1) may transmit to wireless communication device 102 (FIG. 1) the response 143 (FIG. 1) including the sensor-based position information, e.g., as described above.

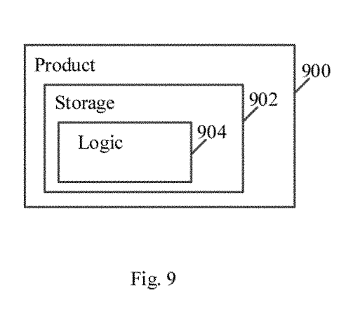

Reference is made to FIG. 9, which schematically illustrates a product of manufacture 900, in accordance with some demonstrative embodiments. Product 900 may include one or more tangible computer-readable non-transitory storage media 902, which may include computer-executable instructions, e.g., implemented by logic 904, operable to, when executed by at least one computer processor, enable the at least one computer processor to implement one or more operations at wireless communication device 102 (FIG. 1), wireless communication device 140 (FIG. 1), radios 114 and/or 144 (FIG. 1), transmitters 118 and/or 148 (FIG. 1), receivers 116 and/or 146 (FIG. 1), controller 124 (FIG. 1), controller 154 (FIG. 1), message processor 128 (FIG. 1), message processor 158 (FIG. 1), FTM component 117 (FIG. 1), and/or FTM component 157 (FIG. 1), and/or to perform, trigger and/or implement one or more operations and/or functionalities above with reference to FIGS. 1, 2, 3, 4, 5, 6, 7 and/or 8, and/or one or more operations described herein. The phrase “non-transitory machine-readable medium” is directed to include all computer-readable media, with the sole exception being a transitory propagating signal.

In some demonstrative embodiments, product 900 and/or storage media 902 may include one or more types of computer-readable storage media capable of storing data, including volatile memory, non-volatile memory, removable or non-removable memory, erasable or non-erasable memory, writeable or re-writeable memory, and the like. For example, storage media 902 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 904 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 904 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

### EXAMPLES

The following examples pertain to further embodiments.

Example 1 includes an apparatus comprising logic and circuitry configured to cause a mobile station to transmit to a wireless station a request for sensor-based position information corresponding to a change in a position of the wireless station; process a response from the wireless station, the response comprising the sensor-based position information corresponding to the change in the position of the wireless station; and estimate a location of the mobile station based at least on a Time of Flight (ToF) measurement between the mobile station and the wireless station, and the sensor-based position information corresponding to the change in the position of the wireless station.

Example 2 includes the subject matter of Example 1, and optionally, wherein the sensor-based position information comprises at least displacement information corresponding to a displacement of the wireless station relative to a previous position of the wireless station when providing previous position information.

Example 3 includes the subject matter of Example 1 or 2, and optionally, wherein the sensor-based position information comprises at least velocity information corresponding to a velocity of the wireless station.

Example 4 includes the subject matter of any one of Examples 1-3, and optionally, wherein the sensor-based position information comprises at least multi-axis accelerometer information corresponding to the wireless station.

Example 5 includes the subject matter of any one of Examples 1-4, and optionally, wherein the sensor-based position information comprises at least six degrees of freedom (6DOF) information corresponding to the wireless station.

Example 6 includes the subject matter of any one of Examples 1-5, and optionally, wherein the sensor-based position information corresponds to the change in the position of the wireless station represented in at least three axes.

Example 7 includes the subject matter of any one of Examples 1-6, and optionally, wherein the sensor-based position information comprises at least one value corresponding to the change in the position of the wireless station, and an estimated error of the at least one value.

Example 8 includes the subject matter of any one of Examples 1-7, and optionally, wherein the sensor-based position information indicates a change in at least one of a location of the wireless station, or an orientation of the wireless station.

Example 9 includes the subject matter of any one of Examples 1-8, and optionally, wherein the apparatus is configured to cause the mobile station to transmit a Fine Timing Measurement (FTM) request comprising the request for sensor-based position information, and to process an FTM response comprising the sensor-based position information and one or more timing values of the ToF measurement.

Example 10 includes the subject matter of any one of Examples 1-8, and optionally, wherein the apparatus is configured to cause the mobile station to transmit a Location Configuration Information (LCI) request comprising the request for sensor-based position information, and to process an LCI response comprising the sensor-based position information.

Example 11 includes the subject matter of any one of Examples 1-10, and optionally, comprising a Machine to Machine (M2M) station, a vehicular station, or an Internet of Things (IoT) station.

Example 12 includes the subject matter of any one of Examples 1-11, and optionally, comprising a radio to transmit the request and receive the response.

Example 13 includes the subject matter of any one of Examples 1-12, and optionally, comprising one or more antennas, a memory, and a processor.

Example 14 includes a system of wireless communication comprising a mobile station, the mobile station comprising one or more antennas; a radio; a memory; a processor; and a controller configured to cause the mobile station to transmit to a wireless station a request for sensor-based position information corresponding to a change in a position of the wireless station; process a response from the wireless station, the response comprising the sensor-based position information corresponding to the change in the position of the wireless station; and estimate a location of the mobile station based at least on a Time of Flight (ToF) measurement between the mobile station and the wireless station, and the sensor-based position information corresponding to the change in the position of the wireless station.

Example 15 includes the subject matter of Example 14, and optionally, wherein the sensor-based position information comprises at least displacement information corresponding to a displacement of the wireless station relative to a previous position of the wireless station when providing previous position information.

Example 16 includes the subject matter of Example 14 or 15, and optionally, wherein the sensor-based position information comprises at least velocity information corresponding to a velocity of the wireless station.

Example 17 includes the subject matter of any one of Examples 14-16, and optionally, wherein the sensor-based position information comprises at least multi-axis accelerometer information corresponding to the wireless station.

Example 18 includes the subject matter of any one of Examples 14-17, and optionally, wherein the sensor-based position information comprises at least six degrees of freedom (6DOF) information corresponding to the wireless station.

Example 19 includes the subject matter of any one of Examples 14-18, and optionally, wherein the sensor-based position information corresponds to the change in the position of the wireless station represented in at least three axes.

Example 20 includes the subject matter of any one of Examples 14-19, and optionally, wherein the sensor-based position information comprises at least one value corresponding to the change in the position of the wireless station, and an estimated error of the at least one value.

Example 21 includes the subject matter of any one of Examples 14-20, and optionally, wherein the sensor-based position information indicates a change in at least one of a location of the wireless station, or an orientation of the wireless station.

Example 22 includes the subject matter of any one of Examples 14-21, and optionally, wherein the controller is configured to cause the mobile station to transmit a Fine Timing Measurement (FTM) request comprising the request for sensor-based position information, and to process an FTM response comprising the sensor-based position information and one or more timing values of the ToF measurement.

Example 23 includes the subject matter of any one of Examples 14-21, and optionally, wherein the controller is configured to cause the mobile station to transmit a Location Configuration Information (LCI) request comprising the request for sensor-based position information, and to process an LCI response comprising the sensor-based position information.

Example 24 includes the subject matter of any one of Examples 14-23, and optionally, wherein the mobile station comprises a Machine to Machine (M2M) station, a vehicular station, or an Internet of Things (IoT) station.

Example 25 includes a method to be performed at a mobile station, the method comprising transmitting to a wireless station a request for sensor-based position information corresponding to a change in a position of the wireless station; processing a response from the wireless station, the response comprising the sensor-based position information corresponding to the change in the position of the wireless station; and estimating a location of the mobile station based at least on a Time of Flight (ToF) measurement between the mobile station and the wireless station, and the sensor-based position information corresponding to the change in the position of the wireless station.

Example 26 includes the subject matter of Example 25, and optionally, wherein the sensor-based position information comprises at least displacement information corresponding to a displacement of the wireless station relative to a previous position of the wireless station when providing previous position information.

Example 27 includes the subject matter of Example 25 or 26, and optionally, wherein the sensor-based position information comprises at least velocity information corresponding to a velocity of the wireless station.

Example 28 includes the subject matter of any one of Examples 25-27, and optionally, wherein the sensor-based position information comprises at least multi-axis accelerometer information corresponding to the wireless station.

Example 29 includes the subject matter of any one of Examples 25-28, and optionally, wherein the sensor-based position information comprises at least six degrees of freedom (6DOF) information corresponding to the wireless station.

Example 30 includes the subject matter of any one of Examples 25-29, and optionally, wherein the sensor-based position information corresponds to the change in the position of the wireless station represented in at least three axes.

Example 31 includes the subject matter of any one of Examples 25-30, and optionally, wherein the sensor-based position information comprises at least one value corresponding to the change in the position of the wireless station, and an estimated error of the at least one value.

Example 32 includes the subject matter of any one of Examples 25-31, and optionally, wherein the sensor-based position information indicates a change in at least one of a location of the wireless station, or an orientation of the wireless station.

Example 33 includes the subject matter of any one of Examples 25-32, and optionally, comprising transmitting a Fine Timing Measurement (FTM) request comprising the request for sensor-based position information, and processing an FTM response comprising the sensor-based position information and one or more timing values of the ToF measurement.

Example 34 includes the subject matter of any one of Examples 25-32, and optionally, comprising transmitting a Location Configuration Information (LCI) request comprising the request for sensor-based position information, and processing an LCI response comprising the sensor-based position information.

Example 35 includes the subject matter of any one of Examples 25-34, and optionally, wherein the mobile station comprises a Machine to Machine (M2M) station, a vehicular station, or an Internet of Things (IoT) station.

Example 36 includes a product comprising one or more tangible computer-readable non-transitory storage media comprising computer-executable instructions operable to, when executed by at least one computer processor, enable the at least one computer processor to implement operations at a mobile station, the operations comprising transmitting to a wireless station a request for sensor-based position information corresponding to a change in a position of the wireless station; processing a response from the wireless station, the response comprising the sensor-based position information corresponding to the change in the position of the wireless station; and estimating a location of the mobile station based at least on a Time of Flight (ToF) measurement between the mobile station and the wireless station, and the sensor-based position information corresponding to the change in the position of the wireless station.

Example 37 includes the subject matter of Example 36, and optionally, wherein the sensor-based position information comprises at least displacement information corresponding to a displacement of the wireless station relative to a previous position of the wireless station when providing previous position information.

Example 38 includes the subject matter of Example 36 or 37, and optionally, wherein the sensor-based position information comprises at least velocity information corresponding to a velocity of the wireless station.

Example 39 includes the subject matter of any one of Examples 36-38, and optionally, wherein the sensor-based position information comprises at least multi-axis accelerometer information corresponding to the wireless station.

Example 40 includes the subject matter of any one of Examples 36-39, and optionally, wherein the sensor-based position information comprises at least six degrees of freedom (6DOF) information corresponding to the wireless station.

Example 41 includes the subject matter of any one of Examples 36-40, and optionally, wherein the sensor-based position information corresponds to the change in the position of the wireless station represented in at least three axes.

Example 42 includes the subject matter of any one of Examples 36-41, and optionally, wherein the sensor-based position information comprises at least one value corresponding to the change in the position of the wireless station, and an estimated error of the at least one value.

Example 43 includes the subject matter of any one of Examples 36-42, and optionally, wherein the sensor-based position information indicates a change in at least one of a location of the wireless station, or an orientation of the wireless station.

Example 44 includes the subject matter of any one of Examples 36-43, and optionally, wherein the operations comprise transmitting a Fine Timing Measurement (FTM) request comprising the request for sensor-based position information, and processing an FTM response comprising the sensor-based position information and one or more timing values of the ToF measurement.

Example 45 includes the subject matter of any one of Examples 36-43, and optionally, wherein the operations comprise transmitting a Location Configuration Information (LCI) request comprising the request for sensor-based position information, and processing an LCI response comprising the sensor-based position information.

Example 46 includes the subject matter of any one of Examples 36-45, and optionally, wherein the mobile station comprises a Machine to Machine (M2M) station, a vehicular station, or an Internet of Things (IoT) station.

Example 47 includes an apparatus of a mobile station, the apparatus comprising means for transmitting to a wireless station a request for sensor-based position information corresponding to a change in a position of the wireless station; means for processing a response from the wireless station, the response comprising the sensor-based position information corresponding to the change in the position of the wireless station; and means for estimating a location of the mobile station based at least on a Time of Flight (ToF) measurement between the mobile station and the wireless station, and the sensor-based position information corresponding to the change in the position of the wireless station.

Example 48 includes the subject matter of Example 47, and optionally, wherein the sensor-based position information comprises at least displacement information corresponding to a displacement of the wireless station relative to a previous position of the wireless station when providing previous position information.

Example 49 includes the subject matter of Example 47 or 48, and optionally, wherein the sensor-based position information comprises at least velocity information corresponding to a velocity of the wireless station.

Example 50 includes the subject matter of any one of Examples 47-49, and optionally, wherein the sensor-based position information comprises at least multi-axis accelerometer information corresponding to the wireless station.

Example 51 includes the subject matter of any one of Examples 47-50, and optionally, wherein the sensor-based position information comprises at least six degrees of freedom (6DOF) information corresponding to the wireless station.

Example 52 includes the subject matter of any one of Examples 47-51, and optionally, wherein the sensor-based position information corresponds to the change in the position of the wireless station represented in at least three axes.

Example 53 includes the subject matter of any one of Examples 47-52, and optionally, wherein the sensor-based position information comprises at least one value corresponding to the change in the position of the wireless station, and an estimated error of the at least one value.

Example 54 includes the subject matter of any one of Examples 47-53, and optionally, wherein the sensor-based position information indicates a change in at least one of a location of the wireless station, or an orientation of the wireless station.

Example 55 includes the subject matter of any one of Examples 47-54, and optionally, comprising means for transmitting a Fine Timing Measurement (FTM) request comprising the request for sensor-based position information, and processing an FTM response comprising the sensor-based position information and one or more timing values of the ToF measurement.

Example 56 includes the subject matter of any one of Examples 47-54, and optionally, comprising means for transmitting a Location Configuration Information (LCI) request comprising the request for sensor-based position information, and processing an LCI response comprising the sensor-based position information.

Example 57 includes the subject matter of any one of Examples 47-56, and optionally, wherein the mobile station comprises a Machine to Machine (M2M) station, a vehicular station, or an Internet of Things (IoT) station.

Example 58 includes an apparatus comprising logic and circuitry configured to cause a first wireless station to receive a request from a second wireless station for sensor-based position information corresponding to a change in a position of the first wireless station; determine the sensor-based position information based on sensor measurements from one or more sensors of the first wireless station; and transmit to the second wireless station a response comprising the sensor-based position information.

Example 59 includes the subject matter of Example 58, and optionally, wherein the sensor-based position information comprises at least displacement information corresponding to a displacement of the first wireless station relative to a previous position of the first wireless station when providing previous position information.

Example 60 includes the subject matter of Example 58 or 59, and optionally, wherein the sensor-based position information comprises at least velocity information corresponding to a velocity of the first wireless station.

Example 61 includes the subject matter of any one of Examples 58-60, and optionally, wherein the sensor-based position information comprises at least multi-axis accelerometer information corresponding to the first wireless station.

Example 62 includes the subject matter of any one of Examples 58-61, and optionally, wherein the sensor-based position information comprises at least six degrees of freedom (6DOF) information corresponding to the first wireless station.

Example 63 includes the subject matter of any one of Examples 58-62, and optionally, wherein the sensor-based position information corresponds to the change in the position of the first wireless station represented in at least three axes.

Example 64 includes the subject matter of any one of Examples 58-63, and optionally, wherein the sensor-based position information comprises at least one value corresponding to the change in the position of the first wireless station, and an estimated error of the at least one value.

Example 65 includes the subject matter of any one of Examples 58-64, and optionally, wherein the sensor-based position information indicates a change in at least one of a location of the first wireless station, or an orientation of the first wireless station.

Example 66 includes the subject matter of any one of Examples 58-65, and optionally, wherein the apparatus is configured to cause the first wireless station to process a Fine Timing Measurement (FTM) request comprising the request for sensor-based position information, and to transmit an FTM response comprising the sensor-based position information and one or more timing values of a Time of Flight (ToF) measurement.

Example 67 includes the subject matter of any one of Examples 58-66, and optionally, wherein the apparatus is configured to cause the first wireless station to receive a Location Configuration Information (LCI) request comprising the request for sensor-based position information, and to transmit an LCI response comprising the sensor-based position information.

Example 68 includes the subject matter of any one of Examples 58-67, and optionally, comprising a location responder station.

Example 69 includes the subject matter of any one of Examples 58-68, and optionally, comprising a mobile station.

Example 70 includes the subject matter of any one of Examples 58-69, and optionally, comprising a radio to receive the request and transmit the response.

Example 71 includes the subject matter of any one of Examples 58-70, and optionally, comprising one or more antennas, a memory, and a processor.

Example 72 includes a system of wireless communication comprising a first wireless station, the first wireless station comprising one or more antennas; a radio; a memory; a processor; and a controller configured to cause the first wireless station to receive a request from a second wireless station for sensor-based position information corresponding to a change in a position of the first wireless station; determine the sensor-based position information based on sensor measurements from one or more sensors of the first wireless station; and transmit to the second wireless station a response comprising the sensor-based position information.

Example 73 includes the subject matter of Example 72, and optionally, wherein the sensor-based position information comprises at least displacement information corresponding to a displacement of the first wireless station relative to a previous position of the first wireless station when providing previous position information.

Example 74 includes the subject matter of Example 72 or 73, and optionally, wherein the sensor-based position information comprises at least velocity information corresponding to a velocity of the first wireless station.

Example 75 includes the subject matter of any one of Examples 72-74, and optionally, wherein the sensor-based position information comprises at least multi-axis accelerometer information corresponding to the first wireless station.

Example 76 includes the subject matter of any one of Examples 72-75, and optionally, wherein the sensor-based position information comprises at least six degrees of freedom (6DOF) information corresponding to the first wireless station.

Example 77 includes the subject matter of any one of Examples 72-76, and optionally, wherein the sensor-based position information corresponds to the change in the position of the first wireless station represented in at least three axes.

Example 78 includes the subject matter of any one of Examples 72-77, and optionally, wherein the sensor-based position information comprises at least one value corresponding to the change in the position of the first wireless station, and an estimated error of the at least one value.

Example 79 includes the subject matter of any one of Examples 72-78, and optionally, wherein the sensor-based position information indicates a change in at least one of a location of the first wireless station, or an orientation of the first wireless station.

Example 80 includes the subject matter of any one of Examples 72-79, and optionally, wherein the controller is configured to cause the first wireless station to process a Fine Timing Measurement (FTM) request comprising the request for sensor-based position information, and to transmit an FTM response comprising the sensor-based position information and one or more timing values of a Time of Flight (ToF) measurement.

Example 81 includes the subject matter of any one of Examples 72-80, and optionally, wherein the controller is configured to cause the first wireless station to receive a Location Configuration Information (LCI) request comprising the request for sensor-based position information, and to transmit an LCI response comprising the sensor-based position information.

Example 82 includes the subject matter of any one of Examples 72-81, and optionally, wherein the first wireless station comprises a location responder station.

Example 83 includes the subject matter of any one of Examples 72-82, and optionally, wherein the first wireless station comprises a mobile station.

Example 84 includes a method to be performed at a first wireless station, the method comprising receiving a request from a second wireless station for sensor-based position information corresponding to a change in a position of the first wireless station; determining the sensor-based position information based on sensor measurements from one or more sensors of the first wireless station; and transmitting to the second wireless station a response comprising the sensor-based position information.

Example 85 includes the subject matter of Example 84, and optionally, wherein the sensor-based position information comprises at least displacement information corresponding to a displacement of the first wireless station relative to a previous position of the first wireless station when providing previous position information.

Example 86 includes the subject matter of Example 84 or 85, and optionally, wherein the sensor-based position information comprises at least velocity information corresponding to a velocity of the first wireless station.

Example 87 includes the subject matter of any one of Examples 84-86, and optionally, wherein the sensor-based position information comprises at least multi-axis accelerometer information corresponding to the first wireless station.

Example 88 includes the subject matter of any one of Examples 84-87, and optionally, wherein the sensor-based position information comprises at least six degrees of freedom (6DOF) information corresponding to the first wireless station.

Example 89 includes the subject matter of any one of Examples 84-88, and optionally, wherein the sensor-based position information corresponds to the change in the position of the first wireless station represented in at least three axes.

Example 90 includes the subject matter of any one of Examples 84-89, and optionally, wherein the sensor-based position information comprises at least one value corresponding to the change in the position of the first wireless station, and an estimated error of the at least one value.

Example 91 includes the subject matter of any one of Examples 84-90, and optionally, wherein the sensor-based position information indicates a change in at least one of a location of the first wireless station, or an orientation of the first wireless station.

Example 92 includes the subject matter of any one of Examples 84-91, and optionally, comprising processing a Fine Timing Measurement (FTM) request comprising the request for sensor-based position information, and transmitting an FTM response comprising the sensor-based position information and one or more timing values of a Time of Flight (ToF) measurement.

Example 93 includes the subject matter of any one of Examples 84-92, and optionally, comprising receiving a Location Configuration Information (LCI) request comprising the request for sensor-based position information, and transmitting an LCI response comprising the sensor-based position information.

Example 94 includes the subject matter of any one of Examples 84-93, and optionally, wherein the first wireless station comprises a location responder station.

Example 95 includes the subject matter of any one of Examples 84-94, and optionally, wherein the first wireless station comprises a mobile station.

Example 96 includes a product comprising one or more tangible computer-readable non-transitory storage media comprising computer-executable instructions operable to, when executed by at least one computer processor, enable the at least one computer processor to implement operations at a first wireless station, the operations comprising receiving a request from a second wireless station for sensor-based position information corresponding to a change in a position of the first wireless station; determining the sensor-based position information based on sensor measurements from one or more sensors of the first wireless station; and transmitting to the second wireless station a response comprising the sensor-based position information.

Example 97 includes the subject matter of Example 96, and optionally, wherein the sensor-based position information comprises at least displacement information corresponding to a displacement of the first wireless station relative to a previous position of the first wireless station when providing previous position information.

Example 98 includes the subject matter of Example 96 or 97, and optionally, wherein the sensor-based position information comprises at least velocity information corresponding to a velocity of the first wireless station.

Example 99 b includes the subject matter of any one of Examples 96-98, and optionally, wherein the sensor-based position information comprises at least multi-axis accelerometer information corresponding to the first wireless station.

Example 100 includes the subject matter of any one of Examples 96-99, and optionally, wherein the sensor-based position information comprises at least six degrees of freedom (6DOF) information corresponding to the first wireless station.

Example 101 includes the subject matter of any one of Examples 96-100, and optionally, wherein the sensor-based position information corresponds to the change in the position of the first wireless station represented in at least three axes.

Example 102 includes the subject matter of any one of Examples 96-101, and optionally, wherein the sensor-based position information comprises at least one value corresponding to the change in the position of the first wireless station, and an estimated error of the at least one value.

Example 103 includes the subject matter of any one of Examples 96-102, and optionally, wherein the sensor-based position information indicates a change in at least one of a location of the first wireless station, or an orientation of the first wireless station.

Example 104 includes the subject matter of any one of Examples 96-103, and optionally, wherein the operations comprise processing a Fine Timing Measurement (FTM) request comprising the request for sensor-based position information, and transmitting an FTM response comprising the sensor-based position information and one or more timing values of a Time of Flight (ToF) measurement.

Example 105 includes the subject matter of any one of Examples 96-104, and optionally, wherein the operations comprise receiving a Location Configuration Information (LCI) request comprising the request for sensor-based position information, and transmitting an LCI response comprising the sensor-based position information.

Example 106 includes the subject matter of any one of Examples 96-105, and optionally, wherein the first wireless station comprises a location responder station.

Example 107 includes the subject matter of any one of Examples 96-106, and optionally, wherein the first wireless station comprises a mobile station.

Example 108 includes an apparatus of a first wireless station, the apparatus comprising means for receiving a request from a second wireless station for sensor-based position information corresponding to a change in a position of the first wireless station; means for determining the sensor-based position information based on sensor measurements from one or more sensors of the first wireless station; and means for transmitting to the second wireless station a response comprising the sensor-based position information.

Example 109 includes the subject matter of Example 108, and optionally, wherein the sensor-based position information comprises at least displacement information corresponding to a displacement of the first wireless station relative to a previous position of the first wireless station when providing previous position information.

Example 110 includes the subject matter of Example 108 or 109, and optionally, wherein the sensor-based position information comprises at least velocity information corresponding to a velocity of the first wireless station.

Example 111 includes the subject matter of any one of Examples 108-110, and optionally, wherein the sensor-based position information comprises at least multi-axis accelerometer information corresponding to the first wireless station.

Example 112 includes the subject matter of any one of Examples 108-111, and optionally, wherein the sensor-based position information comprises at least six degrees of freedom (6DOF) information corresponding to the first wireless station.

Example 113 includes the subject matter of any one of Examples 108-112, and optionally, wherein the sensor-based position information corresponds to the change in the position of the first wireless station represented in at least three axes.

Example 114 includes the subject matter of any one of Examples 108-113, and optionally, wherein the sensor-based position information comprises at least one value corresponding to the change in the position of the first wireless station, and an estimated error of the at least one value.

Example 115 includes the subject matter of any one of Examples 108-114, and optionally, wherein the sensor-based position information indicates a change in at least one of a location of the first wireless station, or an orientation of the first wireless station.

Example 116 includes the subject matter of any one of Examples 108-115, and optionally, comprising means for processing a Fine Timing Measurement (FTM) request comprising the request for sensor-based position information, and transmitting an FTM response comprising the sensor-based position information and one or more timing values of a Time of Flight (ToF) measurement.

Example 117 includes the subject matter of any one of Examples 108-116, and optionally, comprising means for receiving a Location Configuration Information (LCI) request comprising the request for sensor-based position information, and transmitting an LCI response comprising the sensor-based position information.

Example 118 includes the subject matter of any one of Examples 108-117, and optionally, wherein the first wireless station comprises a location responder station.

Example 119 includes the subject matter of any one of Examples 108-118, and optionally, wherein the first wireless station comprises a mobile station.

Functions, operations, components and/or features described herein with reference to one or more embodiments, may be combined with, or may be utilized in combination with, one or more other functions, operations, components and/or features described herein with reference to one or more other embodiments, or vice versa.

While certain features of have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising logic and circuitry configured to cause a mobile station to:
transmit to a wireless station a request for sensor-based position information corresponding to a change in a position of the wireless station;
process a response from the wireless station, the response comprising the sensor-based position information corresponding to the change in the position of the wireless station; and
estimate a location of the mobile station based at least on a Time of Flight (ToF) measurement between the mobile station and the wireless station, and the sensor-based position information corresponding to the change in the position of the wireless station.

2. The apparatus of claim 1, wherein the sensor-based position information comprises at least displacement information corresponding to a displacement of the wireless station relative to a previous position of the wireless station when providing previous position information.

3. The apparatus of claim 1, wherein the sensor-based position information comprises at least velocity information corresponding to a velocity of the wireless station.

4. The apparatus of claim 1, wherein the sensor-based position information comprises at least multi-axis accelerometer information corresponding to the wireless station.

5. The apparatus of claim 1, wherein the sensor-based position information comprises at least six degrees of freedom (6DOF) information corresponding to the wireless station.

6. The apparatus of claim 1, wherein the sensor-based position information corresponds to the change in the position of the wireless station represented in at least three axes.

7. The apparatus of claim 1, wherein the sensor-based position information comprises at least one value corresponding to the change in the position of the wireless station, and an estimated error of the at least one value.

8. The apparatus of claim 1, wherein the sensor-based position information indicates a change in at least one of a location of the wireless station, or an orientation of the wireless station.

9. The apparatus of claim 1 configured to cause the mobile station to transmit a Fine Timing Measurement (FTM) request comprising the request for sensor-based position information, and to process an FTM response comprising the sensor-based position information and one or more timing values of the ToF measurement.

10. The apparatus of claim 1 configured to cause the mobile station to transmit a Location Configuration Information (LCI) request comprising the request for sensor-based position information, and to process an LCI response comprising the sensor-based position information.

11. The apparatus of claim 1 comprising a Machine to Machine (M2M) station, a vehicular station, or an Internet of Things (IoT) station.

12. The apparatus of claim 1 comprising a radio to transmit the request and receive the response.

13. The apparatus of claim 1 comprising one or more antennas, a memory, and a processor.

14. A product comprising one or more tangible computer-readable non-transitory storage media comprising computer-executable instructions operable to, when executed by at least one computer processor, enable the at least one computer processor to implement operations at a mobile station, the operations comprising:
transmitting to a wireless station a request for sensor-based position information corresponding to a change in a position of the wireless station;
processing a response from the wireless station, the response comprising the sensor-based position information corresponding to the change in the position of the wireless station; and
estimating a location of the mobile station based at least on a Time of Flight (ToF) measurement between the mobile station and the wireless station, and the sensor-based position information corresponding to the change in the position of the wireless station.

15. The product of claim 14, wherein the sensor-based position information comprises at least displacement information corresponding to a displacement of the wireless station relative to a previous position of the wireless station when providing previous position information.

16. The product of claim 14, wherein the sensor-based position information comprises at least velocity information corresponding to a velocity of the wireless station.

17. The product of claim 14, wherein the operations comprise transmitting a Fine Timing Measurement (FTM) request comprising the request for sensor-based position information, and processing an FTM response comprising the sensor-based position information and one or more timing values of the ToF measurement.

18. An apparatus comprising logic and circuitry configured to cause a first wireless station to:
receive a request from a second wireless station for sensor-based position information corresponding to a change in a position of the first wireless station;
determine the sensor-based position information based on sensor measurements from one or more sensors of the first wireless station; and
transmit to the second wireless station a response comprising the sensor-based position information.

19. The apparatus of claim 18, wherein the sensor-based position information comprises at least displacement information corresponding to a displacement of the first wireless station relative to a previous position of the first wireless station when providing previous position information.

20. The apparatus of claim 18, wherein the sensor-based position information comprises at least velocity information corresponding to a velocity of the first wireless station.

21. The apparatus of claim 18 configured to cause the first wireless station to process a Fine Timing Measurement (FTM) request comprising the request for sensor-based position information, and to transmit an FTM response comprising the sensor-based position information and one or more timing values of a Time of Flight (ToF) measurement.

22. A product comprising one or more tangible computer-readable non-transitory storage media comprising computer-executable instructions operable to, when executed by at least one computer processor, enable the at least one computer processor to implement operations at a first wireless station, the operations comprising:
receiving a request from a second wireless station for sensor-based position information corresponding to a change in a position of the first wireless station;
determining the sensor-based position information based on sensor measurements from one or more sensors of the first wireless station; and
transmitting to the second wireless station a response comprising the sensor-based position information.

23. The product of claim 22, wherein the sensor-based position information comprises at least multi-axis accelerometer information corresponding to the first wireless station.

24. The product of claim 22, wherein the sensor-based position information indicates a change in at least one of a location of the first wireless station, or an orientation of the first wireless station.

25. The product of claim 22, wherein the operations comprise receiving a Location Configuration Information (LCI) request comprising the request for sensor-based position information, and transmitting an LCI response comprising the sensor-based position information.
